(19) United States
(12) Patent Application Publication
(10) Pub. No.: US 2012/0216903 A1
(43) Pub. Date: Aug. 30, 2012

(54) MULTI-LAYER TUBING AND METHOD FOR JOINING

(75) Inventor: Sean Osborne, Waterford, MI (US)

(73) Assignee: Flo-Link, LLC, Waterford, MI (US)

(21) Appl. No.: 13/404,152

(22) Filed: Feb. 24, 2012

Related U.S. Application Data
(60) Provisional application No. 61/447,332, filed on Feb. 28, 2011.

(51) Int. Cl. F16L 11/04; B23P 19/02; B65H 69/08; F16L 11/20

(52) U.S. Cl. 138/137; 29/512; 156/158

(57) ABSTRACT

A multi-layer tube (MLT) to inhibit transmission of water vapor and for flame resistance greater than UL-94 HB includes an inner layer having a melt-extrudable polymeric material including a fluoropolymer and at least one additional layer positioned radially outward of the inner layer and including a flame resistant melt-extrudable polymeric material configured to minimize oxygen permeation. Additional layers may be configured to provide flexibility, oxygen and/or nitrogen barriers, thermal insulation, non-reactive materials, transparency, translucency, structural reinforcement, thermal and/or electrical conductivity, and/or dissipative properties. The MLT may be encased in a bundle cover with another tube element and/or electrically conductive element to form a tube bundle. A method for connecting a MLT to a fluid supply system includes positioning an end of the MLT in proximate contact with a connector interface and joining the MLT to the interface to form a hermetic seal or a low water vapor transmission seal.

### CROSS-REFERENCE TO RELATED APPLICATIONS

This application claims the benefit of U.S. Provisional Patent Application No. 61/447,332, filed Feb. 28, 2011, and which is hereby incorporated by reference in its entirety.

### TECHNICAL FIELD

This invention relates to multi-layer tubing for liquid transport and methods for the joining of multi-layer tubing.

### BACKGROUND

Liquid cooling and other liquid transport applications require specialized tubing for robust, sealed-for-life systems. The tubing and joints must be leak free and robust to thermal cycling over the life of the system. Low water vapor transmission rates allow a minimal quantity of fluid to be used in the liquid cooling system to lower cost and weight. Materials currently used for such applications include metals, rubber and polymers. Each of these existing tubing options has limitations for use as a low water vapor permeation conduit.

Metal tubing is not flexible and joining of the metal tube end can be difficult and costly due to the rigid nature of a metal tube. Rubber tubing is more flexible, however changes in shape of the rubber over time may require servicing of the rubber hose, and make reliable clamping or crimping of a joint including the rubber hose end difficult. The cost of rubber tubing may be significant when materials are added to the rubber to reduce water vapor permeation.

Drawbacks associated with fluoropolymer (FP) tubes include kink resistance, flexural resistance, oxygen permeability and cost. Forming the FP tubing as a corrugated hose addresses the limitations of rubber and metal tubing and improves FP tubing kink resistance and flexural characteristics. However corrugated FP tubing presents other limitations, including high cost, and the need to form the corrugated tube to a specific length for each application, which results a customized tube fit and can present availability and logistics challenges to have the right lengths available in a production environment. Furthermore, discrete corrugated tubing lengths may require considerable design effort related to the initial tubing configuration in a system, and for any design changes thereafter. Poor bonding characteristics limit the means for attachment of the ends of the FP tubing. Finally, corrugated tubing has high oxygen permeation properties which may result in oxidation and degradation of the fluid contained within the tube.

### SUMMARY

A multi-layer tube configured to inhibit transmission of water vapor through the multi-layer tube, and for flame resistance greater than UL-94 HB, is provided. The multi-layer tube includes an inner layer comprising a melt-extrudable polymeric material including a fluoropolymer, and at least one additional layer positioned radially outward of the inner layer, wherein said at least one additional layer comprises a flame resistant polymeric material and may be configured to minimize oxygen permeation through said at least one additional layer. The inner layer and the at least one additional layer are configured in a bonded relationship to each other. The additional layers may include a cover layer and one or more intermediate layers, wherein the additional layers may be configured to provide a combination of one or more functional, structural, operational and/or performance characteristics and/or properties to the multi-layer tubing comprising the additional layers, such as increased flexibility, specialized oxygen and/or nitrogen barriers, thermal insulation, non-plasticized/non-reactive and/or inert materials, transparency and/or translucency, structural reinforcement, thermal and/or electrical conductivity, and/or dissipative properties.

A non-uniform layer to layer interface is described to enhance adhesion between adjacent layers of a multi-layer tube to improve layer to layer bonding, e.g., bond strength and/or adhesion, between the adjacent layers.

In a non-limiting example, the multi-layer tube may be encased in a bundle cover with at least one other element to form a tube bundle. The other element may be at least one of another tube and an electrically conductive element. A plurality of tubes and electrically conductive elements may be encased in a tube bundle.

A method for connecting a multi-layer tube to a fluid supply system is provided. The method includes positioning an end of a multi-layer tube in proximate contact with an interfacing portion of a connector and joining the multi-layer tube to the interfacing portion of the connector to form a seal between the multi-layer tube and the connector. The seal thus formed may be one or more of a long life, hermetic seal and a low water vapor transmission seal. In another configuration, the tube may be extended over a barbed portion of the connection to provide a sealing interface. In a non-limiting example, the tube may be modified such that a portion of the tube comprising the inner layer and a portion of the unmodified tube is extended over the barbed portion. A retaining element, which may be tapered or stepped, may be used to apply pressure to the modified and unmodified portions of the tube extended over the barbed portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional illustration of a multi-layer tube including at least two layers;

FIG. 2 is a schematic cross-sectional illustration of a multi-layer tube including at least three layers;

FIG. 3 is a schematic cross-sectional illustration of a multi-layer tube including a non-uniform bond interface;

FIG. 4 is a schematic cross-sectional illustration of a multi-layer tube comprising a plurality of intermediate layers;

FIG. 5 is a schematic cross-sectional illustration of a tube bundle including a plurality of co-axial tubes, including a multi-layer tube;

FIG. 6 is a schematic cross-sectional illustration of a tube bundle including a plurality of tubes, including at least one multi-layer tube;

FIG. 7 is a schematic cross-sectional illustration of a multi-layer tube and connector assembly in a first configuration;

FIG. 8 is a schematic cross-sectional illustration of a multi-layer tube and connector assembly in a second configuration;

FIG. 9 is a schematic cross-sectional illustration of a multi-layer tube and connector assembly in a third configuration;

FIG. 10 is a schematic cross-sectional illustration of a multi-layer tube and connector assembly in a fourth configuration;

FIG. 11 is a schematic cross-sectional illustration of a multi-layer tube and connector assembly in a fifth configuration;

FIG. 12 is a schematic cross-sectional illustration of a multi-layer tube and connector assembly in a sixth configuration;

FIG. 13 is a schematic cross-sectional illustration of a multi-layer tube and barbed connector assembly in a first configuration;

FIG. 14 is a schematic cross-sectional illustration of a multi-layer tube and barbed connector assembly of a second configuration;

FIG. 15 is a schematic cross-sectional illustration of a multi-layer tube and barbed connector assembly of a third configuration;

FIG. 16 is a schematic illustration of cross-section A-A of FIG. 17;

FIG. 17 is a schematic cross-sectional illustration of a tube bundle and connector assembly;

FIG. 18 is a schematic illustration of cross-section B-B of FIG. 19;

FIG. 19 is a partial schematic cross-sectional illustration of a tube bundle and barbed connector assembly;

FIG. 20 is a schematic illustration of cross-section C-C of FIG. 21;

FIG. 21 is a schematic cross-sectional illustration of an assembly including a barbed connector and a tube bundle including a conductive element;

FIG. 22 is a schematic illustration of cross-section D-D of FIG. 23;

FIG. 23 is a schematic cross-sectional illustration of an assembly including a plurality of barbed connectors and a tube bundle including a conductive element;

FIG. 24 is a schematic cross-sectional illustration of a tube bundle including a multi-layer tube and a plurality of conductive elements;

FIG. 25 is a schematic cross-sectional illustration of a tube bundle including a plurality of tubes and a plurality of conductive elements;

FIG. 26 is a schematic cross-sectional illustration of a tube bundle including a multi-layer tube and a conductive element;

FIG. 27 is a schematic cross-sectional illustration of a multi-layer tube and connector assembly including the tube of FIG. 26;

FIG. 28 is a schematic illustrative diagram of a fluid system including at least one multi-layer tube;

FIG. 29 is a schematic illustrative diagram of a fluid system including a tube bundle;

FIG. 30 is a schematic illustrative diagram of a fluid system including at least one multi-layer tube;

FIG. 31 is a schematic illustrative diagram of a fluid system including a tube bundle and at least one multi-layer tube;

FIG. 32 is a schematic illustrative diagram of a fluid and electrical system including a tube bundle;

FIG. 33 is a schematic illustrative diagram of a fluid and electrical system including a tube bundle;

FIG. 34 is a schematic illustrative diagram of a fluid system including a tube bundle and at least one multi-layer tube; and

FIG. 35 is a schematic illustrative diagram of a fluid system including a tube bundle and at least one multi-layer tube.

### DETAILED DESCRIPTION

Provided herein is a tube constructed of multiple layers, e.g., a multi-layer tube, which addresses the limitations and drawbacks of single layer tubing made of one of metal, rubber, or polymer material. The multi-layer tube, as described herein, is compatible with more robust joining techniques, also provided and described herein, to provide maximum reliability for low permeation tube and joint systems. The multi-layer tube may be structured to provide multiple layers, wherein the thickness and relative orientation of each of the layers may be varied, and wherein each of the tubing layers may differ in material composition and characteristics. The resultant multi-layer tube may be configured to optimize the desirable characteristics or features of the tube layers included therein, while minimizing or compensating for the undesirable characteristics or features of the tube layers, to provide, at a macro level, a tube with improved performance.

Low water vapor tubing and joining systems are used in critical long-life applications where the tubing and joints must be substantially leak free and configured such that the loss of the water based fluid contained or conveyed therein is inconsequential, e.g., negligible. The multi-layer tube configurations, joining configurations, and joining methods provided herein combine the low permeability and chemical resistance characteristics of certain fluoropolymer materials with the mechanical characteristics and lower cost characteristics of complementary materials, to provide flexibility and kink resistant of the tubing comparable to a corrugated fluoropolymer tube, with good chemical, flammability and abrasion resistance for robustness to the external environment.

The multi-layer tube is further configured such that one or more highly inert materials comprising the tube may be in contact with a fluid conveyed within the tube, such that the tube will not affect and or degrade the fluid, and may prevent oxygen from permeating the tube and degrading the fluid. The low permeation characteristics of the multi-layer tubing and joining systems described herein may provide a configuration which may be functionally effective in high performance, possibly sealed for life systems, and in elevated temperature environments. Low permeation tubing and joining technologies allow the parent system to have lower weight and cost by lowering the fluid content or volume requirement of the system. Further, lower required fluid quantities and minimized fluid loss as the result of using low permeation multi-layer tubing and joints may allow fluid reservoirs to be made smaller or to be eliminated. Additionally, where water based fluids are used for liquid cooling applications, temperatures greater than 50 degrees C. may be encountered such that steam transfer may be a consideration which may be addressed by providing a multi-layer tubing exhibiting a low water vapor transfer rate (WVTR).

The low permeation tube and joint configurations described herein may be used to lengthen the service life for the application or reduce maintenance costs for replenishing fluids. This can be particularly important for remote applications like standby power systems. Additionally, the multi-layer tube described herein, which may be referred to herein as Flex-Blok tubing, may be developed to be manufactured on high productivity melt extrusion equipment. Accordingly, the Flex-Blok multi-layer tubing described herein may provide a combination of characteristics which is superior to polymer, rubber and metal tubing and which may be joined using methods and configurations superior to existing tubing joining technologies.

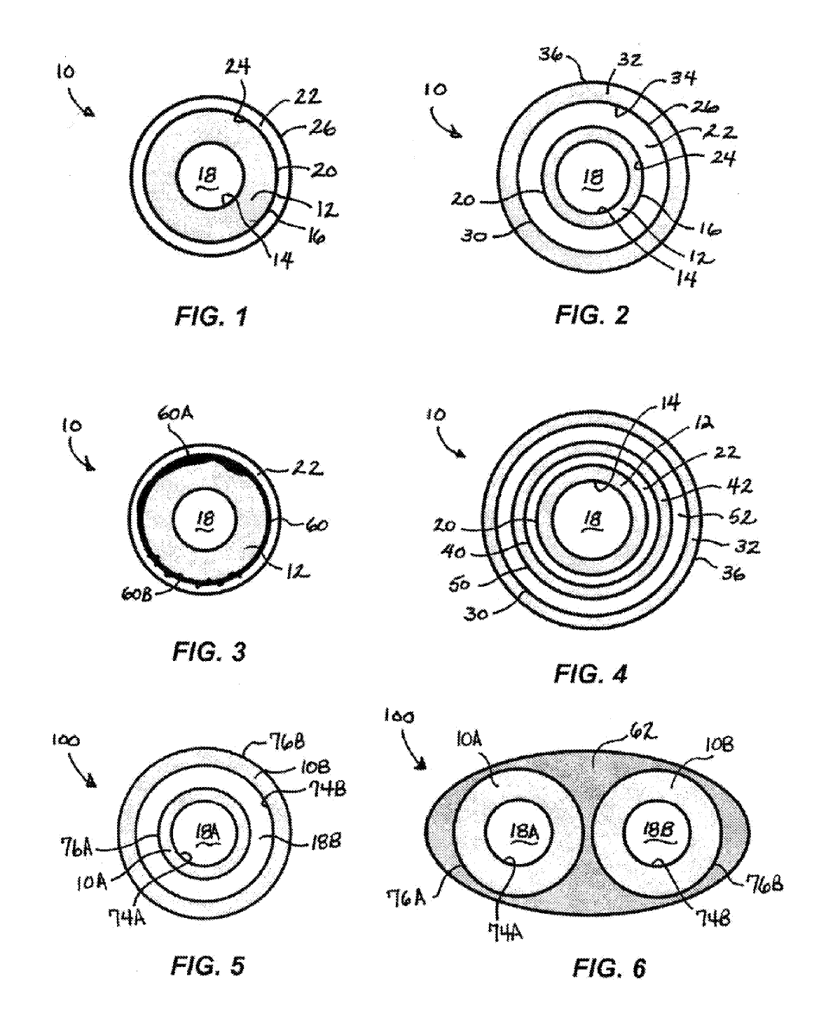

Referring to the drawings wherein like reference numbers represent like components throughout the several figures, the elements shown in FIGS. 1-35 are not to scale or proportion. Accordingly, the particular representations, dimensions and applications provided in the drawings presented herein are not to be considered limiting.

FIG. 1 is a schematic cross-sectional illustration of a multi-layer tube (MLT), generally indicated at 10. The MLT 10 includes a first layer 12 and a second layer 22. The first layer 12 includes an inner or interior surface 14 and an outer or exterior surface 16. The inner surface 14 defines an interior hollow space 18 of the MLT 10, through which fluids including gases and/or liquids, may be conveyed. The second layer 22 includes an inner or interior surface 24 and an outer or exterior surface 26. In the non-limiting example shown in FIG. 1, the second layer 22 is positioned radially outward of the first layer 12. The first layer 12 and second layer 22 are configured in a bonded relationship to each other, such that a bond or interface layer 20 is defined between or at the junction of the outer surface 16 of the first layer 12 and the inner surface 24 of the second layer 22. In a non-limiting example, the MLT 10 may be formed by co-extrusion of the first layer 12 and second layer 22, such that the interface layer 20 is configured during the co-extrusion process. In other non-limiting examples, the interface layer 20 may be provided by one or more of a chemical bond and a mechanical bond formed between the first and second layers 12, 22. The layers 12, 22 and the interface layer 20 of the MLT 10 may each define or provide one or more characteristics and/or functions which in combination define functional and/or performance characteristics of the MLT 10, thereby providing performance characteristics which may not be obtainable from a single layer tube configuration.

The first layer 12 may be configured to contain at least one fluoropolymer material, wherein the fluoropolymer is a functionalized fluoropolymer chosen from the class of fluoropolymers exhibiting characteristics including a low water vapor transmission rate (WVTR) to inhibit the transmission of water vapor, high chemical resistance, and bondability to other polymers. The thickness of the first layer 12 may be varied to provide an effective WVTR barrier. In a non-limiting example, the first layer 12 may be configured with a minimum thickness of 0.2 mm. The fluoropolymer may be functionalized, for example, with a carbonate or carbonyl group, to improve bondability of the first layer 12 to another polymer layer, such as the second layer 22. The first layer 12 may be configured and/or may comprise material or additives to provide flame resistance, adhesion strength, high tensile elongation and moderate flexibility, and high thermal stability. In a non-limiting example, the first layer 12 may be configured as described previously, and specifically, with one or a combination of two or more of a flame resistance greater than UL-94 HB, an adhesion strength of greater than 10N/cm, a tensile elongation of greater than 150%, a flexural modulus (per ASTM D790) of approximately 600 MPA, and a flexural cycling resistance (MIT flex resistance per ASTM D2176) of greater than 10,000 cycles.

One or both of the first layer 12 and the second layer 22 may be chemically modified such that the first fluoropolymer layer 12 may be chemically bonded to the second functionalized polymer layer 22, for example, during a co-extrusion process forming the MLT 10.

The second layer 22 may be made from at least one functionalized polymer or elastomer, and may include one or more additives, such that the second layer 22 is configured to exhibit characteristics including adhesion strength, good elongation, low oxygen permeability, moderate flexibility, high impact strength, and good thermal stability. In a non-limiting example, the second layer 22 may be configured as described previously, and specifically to provide one or a combination of adhesion strength greater than 10N/cm, and a flexural modulus less than 1000 MPa. The thickness of the second layer 22 may be varied, e.g., may be increased, to improve kink resistance. One of the additives to the second layer 22 may be a plasticizer to improve the flexural modulus of the layer 22.

The MLT 10 provided by the combination of the first and second layers 12, 22 may be characterized by a low WVTR, low oxygen permeability, flame resistance better than UL-94 HB, elongation >150%, kink resistance, flexibility, impact strength, shape (low creep) and thermal stability, chemical and abrasion resistance, and resistance to environmental and weatherability (UV, ozone, oxygen) attack. The MLT 10 may be further characterized by good processability (for example, by a high melt flow rate, e.g., a melt flow rate which is sufficient to facilitate volume production processing of the MLT 10) to facilitate forming of the MLT 10 by co-extrusion of the layers 12, 22. In a non-limiting example, the MLT 10 may be characterized as described previously, and specifically, by one or a combination of two or more of a WVTR of less than 1.2 mg/m/hour @60 C; oxygen permeability sufficiently low to minimize degradation of the life of the fluid conveyed in the MLT 10; flame resistance better than UL-94 HB; elongation >150%, sufficient chemical resistance to minimize leaching or contamination of the fluid conveyed in the MLT 10; flexural resistance (per ASTM D2176) greater than 10,000 cycles; a Vicat softening temperature of the softest layer (per ISO 306 @10N) of greater than 125 C, or as required by application, greater than 140 C; an abrasion resistance (per DIN 53516) greater than 50; and an impact strength (per Charpy notched impact @23 C) greater than 40 kJ/m2. Further, the MLT 10 may be configured such that the combined wall thickness of the first and second layers 12, 22 is sufficiently thick to provide good kink resistance and flexibility, which may require varying the thickness and/or stiffness characteristics of one or the other of the layers to provide, in a non-limiting example, a combined flexural modulus of less than 800 MPa, or as required by application, less than 600 MPa.

FIG. 2 shows a schematic cross-sectional illustration of a MLT, generally indicated at 10 and including three layers 12, 22, 32. Each of the three layers 12, 22, 32 may be made from a material configured and/or including one or more additives such that each of the three layers 12, 22, 32 is bondable to its adjacent layer or layers, by one or more of chemical bonding, mechanical bonding, or bonding through co-extrusion. In the non-limiting example shown in FIG. 2, the third layer 32 is positioned radially outward of the first and second layers 12, 22, to provide a cover or jacket for the MLT 10, and may be referred to herein as a cover layer 32. The third layer 32 defines an exterior or outer surface 36 and an interior or inner surface 34. The third layer 32 is in a bondable relationship with the second layer 22 to provide an interface or bond layer 30 between or at the junction of the outer surface 26 of the second layer 22 and the inner surface 34 of the third layer 32. The first layer 12 may comprise at least one functionalized fluoropolymer, and may be configured and exhibit the characteristics as described for FIG. 1, including a low WVTR, high chemical resistance, and bondability to other polymers.

The cover layer 32 may be made of a polymer or elastomer, and may include one or more additives to provide the desired performance characteristics, which may include one or more of flame resistance, an oxygen barrier or low oxygen permeability, and abrasion resistance. The cover layer 32 may further provide a nitrogen barrier or low nitrogen permeability. The cover layer 32 may be configured of a material characterized by or including one or more flame retardants to provide a minimum flame resistance greater than UL-94 HB. In a non-limiting example, the cover layer 32 may be configured to provide one or more of a higher level of flame resistance, such as UL-94 VO or V1 rating, to provide a non-flammable cover for the MLT 10. The cover layer 32 may be additionally configured to provide high tensile elongation, abrasion resistance, chemical resistance, aging and thermal stability, and high impact and flexural fatigue strength. In a non-limiting example, the cover layer 32 may be characterized by a tensile elongation of greater than 150%.

In the MLT 10 shown in FIG. 2, the second layer 22 may be configured as described for FIG. 1. In a non-limiting example, the configuration of the second layer 22 may vary from the configuration described for FIG. 1, to optimize or increase certain performance characteristics of the second layer 22. In a non-limiting example, the materials and/or additives comprising the second layer 22 may be selected to optimize bondability and kink resistance (flexibility) of that layer, such that the bondability and kink resistance of the MLT 10 including layers 12, 22 32 may be optimized. It would be understood that other characteristics of the second layer 22, such as abrasion or laceration resistance, oxygen permeability, flame resistance, etc. may be limited when optimizing bondability and flexibility characteristics within the second layer 22. These characteristics limited in the second layer 22 may be provided for the MLT 10 by another layer, such as a layer 32, combined with the second layer to form the MLT 10. In the non-limiting example described herein, the cover layer 32 could provide the abrasion resistance, low oxygen permeability and flame resistance characteristics defining the MLT 10. It would be understood that the materials and additives comprising the three layers 12, 22, 32 are configured such that when the layers 12, 22, 32 are provided in a bonded relationship to form the MLT 10, the MLT 10 may be characterized by a combination of characteristics including a low WVTR, low oxygen permeability, flame resistance better than UL-94 HB, kink resistance, flexibility, impact strength, shape (low creep) and thermal stability, chemical and abrasion resistance, and resistance to environmental and weatherability (UV, ozone, oxygen) attack. The MLT 10, as shown in FIG. 2, may be further characterized by good processability which is sufficient to facilitate volume production processing of the MLT 10, for example, to facilitate forming of the MLT 10 by co-extrusion of the layers 12, 22, 32.

FIG. 3 is a schematic cross-sectional illustration, in a non-limiting example, of a MLT including a non-uniform bond interface 60 formed, between the adjacent layers of the MLT 10, to improve layer to layer bonding, e.g., bond strength and/or adhesion, between the adjacent layers. It would be understood that the bond interface 60 as shown in FIG. 3 may not be to scale or proportion, and characteristics thereof may be exaggerated for purposes of illustration. It would be understood that the non-uniform bond interface 60 may be formed between any two adjacent layers in a MLT 10, for example, any one or more of the bond interfaces 20, 30, 40, 50 shown in FIGS. 1, 2 and 4 may be configured as a non-uniform bond interface 60, to improve bonding and/or adhesion between the adjacent layers forming the respective bond interface 20, 30, 40, 50, to improve bonding and/or adhesion of the tubing layers when the MLT 10 is subjected to flexing, bending, twisting, coiling, or other manipulation. The non-uniform bond layer 60 may be defined by one or more of a non-circular cross section, variation in thickness within a cross-section (see 60A in FIG. 3) and/or longitudinally, profile irregularities such as peaks, valleys, ridges, etc., and/or other deviations (see for example, 60 B in FIG. 3) from a smooth, continuous or uniform configuration, in a cross-sectional or longitudinal direction. The non-uniformity of the bond layer 60 may improve the adhesion between the adjacent layers bonded to form the bond layer 60, for example, by increasing the surface area of the bond layer 60 when compared to a uniform bond interface. The bond layer 60 may be formed in a non-uniform configuration during co-extrusion, for example, by providing irregularities in the surface profiles of one or both the of the adjacent surfaces bonding to form the interface layer 60. Either or both of the bonding surfaces, which in the example shown in FIG. 3, are the inner surface 24 of the outer layer 22 and the outer surface 16 of the inner layer 12 (see FIG. 1) may be made irregular by forming the respective layers of non-uniform thickness, by extruding these surfaces in a non-circular or otherwise non-uniform profile, or by forming (by extrusion or otherwise) discontinuities in or on the respective surface, such as ridges, bumps, dimples, or undulations, or other irregularities which may contribute to formation of a irregular or non-uniform bond interface 60. In a non-limiting example, the outer surface of the first fluoropolymer layer 12 may be configured with a non-uniform profile to facilitate formation of the bond interface 20 as a non-uniform bond layer 60, thereby improving the bondability of the fluoropolymer material comprising the first layer 12 to an adjacent layer, by increasing the total surface area and introducing irregularities in the bond profile of the bond interface 20. The bondability of the fluoropolymer material of the first layer 12 can thereby be improved by using either or a combination of chemical modification of the fluoropolymer layer 12 to improve chemical bonding of the layer 12, and physical modification of the interface surface 16 (of the present example) to provide an irregular or non-uniform bond layer 60, thereby improving adhesion strength between the fluoropolymer layer 12 and its adjacent layer.

In another non-limiting example, the middle layer of a MLT 10, such as the layer 22 of the MLT 10 shown in FIG. 2, may be provided, e.g., formed or extruded, to the co-extrusion process forming the MLT 10 with an irregular or non-uniform profile or with surface irregularities or discontinuities formed on both the inner surface 24 and outer surface 26, such that both bonding layers 20, 30 are formed as non-uniform bonding interfaces 60. By configuring the middle layer 22 to provide the non-uniform profile resulting in formation of non-uniform interfaces at the bonding surfaces 20, 30, the adjacent layers, in the present example the inner first layer 12 and the outer third layer 32, may be provided as uniform layers, which may be the desired configuration to optimize the characteristics of these layers 12, 32 to produce the desired performance features and/or a uniform inner surface profile 14 and outer surface profile 16 of the resultant MLT 10 formed therefrom.

It would be understood that a similar process or method may be used to form a non-uniform bonding interface 60 between two adjacent layers of a non-tubular multi-layer element. For example, a generally flat multi-layer sheet may be formed wherein at least one layer comprising the sheet may not be planar and/or rather may be defined by non-uniform irregularities or other profile variation causing improved adhesion with the adjacent layer to which it is bonded. Such variation in layer thickness could be longitudinal as well as transverse to the orientation of the multi-layer element.

FIG. 4 is a schematic cross-sectional illustration of a multi-layer tube comprising at least one intermediate layer and generally indicated at 10. The MLT 10 comprises an inner first layer 12, a second layer 22, an outer third layer 32, and at least one intermediate layer represented by the intermediate layers 42, 52. In a non-limiting example shown in FIG. 4, the MLT 10 is configured with two intermediate layers 42, 52. Each respective intermediate layer 42, 52 is defined by an inner surface and an outer surface, where each of the inner and outer surfaces of each respective intermediate layer defines an interface or bonding layer with an adjacent layer. In the example shown in FIG. 4, the inner surface of the intermediate layer 42 and the outer surface of the second layer 22 define a bonding layer 40. The outer surface of the intermediate layer 42 and the inner surface of the intermediate layer 52 define a bonding layer 50. The outer surface of the second layer 22 and the inner surface of the cover layer 32 define a bonding layer 30. It would be understood that the order of the layers may be varied to vary the performance characteristics and properties of the MLT 10, for example and referring to FIG. 4, in an alternate configuration the intermediate layer 52 may be placed radially inward of the intermediate layer 42. It would be understood that the MLT 10 may be comprised of one intermediate layer, or a plurality of two or more intermediate layers, within the scope described herein, and that the configuration shown in FIG. 4 is not intended to be limiting.

By adding one or more intermediate layers, the materials and additives comprising the three layers 12, 22, 32 and the one or more intermediate layers may be configured such that when the layers 12, 22, 32 and the intermediate layers, e.g., at least one of the layers 42, 52, are provided in a bonded relationship to form the MLT 10, the MLT 10 may be characterized at least by a low WVTR, low oxygen permeability, flame resistance better than UL-94 HB, elongation greater than 150%, kink resistance, flexibility, impact strength, shape (low creep) and thermal stability, chemical and abrasion resistance, and resistance to environmental and weatherability (UV, ozone, oxygen) attack, and may be further characterized by a processability which is sufficient to facilitate volume production processing of the MLT 10, for example, to facilitate forming of the MLT 10 by co-extrusion of the layers 12, 22, 32 and the one or more intermediate layers 42, 52. The intermediate layers may be configured to contribute functional, structural, operational and/or performance characteristics and/or properties to the MLT 10 comprising the intermediate layers, such as increased flexibility, specialized oxygen and/or nitrogen barriers, thermal insulation, non-plasticized/non-reactive and/or inert materials, transparency and/or translucency, structural reinforcement, thermal and/or electrical conductivity, and/or dissipative properties.

A MLT 10 comprising of one or more intermediate layers may be characterized at a minimum by a first inner layer 12 defining a fluoropolymer material with a low WVTR, a second layer 22 defining a functionalized polymer bondable to the fluoropolymer material and defined by good adhesion strength, and a third cover layer 32 defined by a minimum flame resistance of greater than UL94 HB. The intermediate layers may be configured to provide, in combination with layers 12, 22, 32, a combination of functional, structural, operational and/or performance characteristics and/or properties as required to provide reliable performance in the operating environment for which the MLT 10 is designed to function. It would be understood that a characteristic or property may be limited in one layer and optimized in another layer, to provide the combined characteristics or properties required for overall performance of the MLT 10.

In a series of non-limiting examples, various optional configurations of an intermediate layer, which for illustrative purposes will be referred to as an intermediate layer 42, but which may be understood to be one of the intermediate layer in a MLT 10 comprising one intermediate layer, or one of a plurality of intermediate layers comprising a MLT 10 including two or more intermediate layers, will be described. In each of the series of non-limiting examples, an intermediate layer may be described by a defining characteristic. The reference to a defining characteristic is not intended to limit other characteristics or properties which may be embodied in that the intermediate layer and one or more defining characteristics may be combined in a single intermediate layer within the scope of a MLT 10 as described herein.

In a first non-limiting example, an intermediate layer 42 may be configured as a more flexible layer, e.g., the intermediate layer 42 may be defined by greater flexibility than each of the other layers comprising the MLT 10, and may be referred to, in the instant example, as a flexible layer 42. The flexible layer 42 may be co-extrudable and bondable to mating materials, including mating materials comprising the tubing layers adjacent to the flexible layer 42. The flexible layer 42 may be comprised, for example, of a polymeric material suitable for use as a flexible mono-wall tube, such as an elastomer, which may be, in a non-limiting example, a thermoplastic elastomer (TPE). The flexible layer 42 may be defined, in a non-limiting example, by a flexural modulus of at least 250 MPA and/or an elongation of at least 200% and preferable greater than 300%. The thickness of the flexible layer 42 may be varied or configured at a minimum to provide good kink resistance to the MLT 10, and may additionally exhibit oxygen barrier properties.

In a second non-limiting example, an intermediate layer 42 may be configured as a barrier layer, e.g., the intermediate layer 42 may be defined by greater oxygen barrier and/or greater nitrogen barrier performance characteristics than each of the other layers comprising the MLT 10, and may be referred to, in the instant example, as a barrier layer 42 comprising, in a non-limiting example, a very low oxygen permeation material. The barrier layer 42 may be co-extrudable and bondable to mating materials, including mating materials comprising the tubing layers adjacent to the barrier layer 42. The barrier layer 42 may be comprised, for example, of a polymeric material similar to materials used in fuel applications as a hydrocarbon and/or alcohol barrier, to reduce oxygen and/or nitrogen permeability. In a non-limiting example, the polymeric material may include an Ethylene Vinyl Alcohol (EVOH) material. The barrier layer 42 may be defined, in a non-limiting example, by one of a nitrogen permeability of less than 1.0 cc·mm/m²/day·ATM or preferably less than 0.5 cc·mm/m²/day·ATM, and an oxygen permeability of less than 10.0 cc·mm/m²/day·ATM or preferably less than 2.0 cc·mm/m²/day·ATM. The barrier layer 42 may be configured as a thin layer in comparison to the thickness of other layers of the MLT 10, being of sufficient thickness to provide the barrier characteristics required by the application for which the MLT 10 is specified.

In a third non-limiting example, an intermediate layer 42 may be configured as a thermal insulation layer, e.g., the intermediate layer 42 may be defined by greater thermal insulating characteristics and/or lower thermal conduction than each of the other layers comprising the MLT 10, and may be referred to, in the instant example, as a thermal insulation layer 42. The thermal insulation layer 42 may be co-extrudable and bondable to mating materials, including mating materials comprising the tubing layers adjacent to the thermal insulation 42. The thermal insulation layer 42 may be comprised, for example, of a polymeric material from any polymer class suitable for use as an insulating material, such as a foamed polyamide, which may be effective to reduce the heat dissipated from or admitted to the MLT 10 or fluid contained in and/or conveyed through the MLT 10. The thermal insulation layer 42 may be formed of a foamed polymer, which may be configured with entrapped air bubbles to improve insulating performance. The thickness of the thermal insulation layer 42 may be varied or configured at a minimum to provide good thermal insulating properties to the MLT 10, and which may include low thermal conductivity. In a non-limiting example, the insulating layer can be situated as a cover layer 32 or as an intermediate layer 42. The insulating layer, when configured as a cover layer 32, may be additionally characterized by at least one of abrasion resistance, flammability resistance of greater than UL94 HB, and other functional characteristics required for a cover layer 32, as described previously.

In a fourth non-limiting example, an intermediate layer 42 may be configured as a non-plasticized layer, such that the intermediate layer 42 may be inert and/or non-reactive to the fluid contained in and/or conveyed through the MLT 10, and therefore suitable for use in medical or food-related applications. Plasticizers, which may be used to make plastic materials such as the materials comprising one or more of the layers of the MLT 10 more flexible, may leach into and potentially affect the fluid flowing through the MLT 10, which may make the MLT 10 less suitable for used in certain applications, such as certain medical, food, potable water, product testing, semiconductor or other applications which may be sensitive to a contamination of the conveyed fluid by a leached constituent such as a plasticizer. This potential problem may be addressed by configuring the MLT 10 to include an intermediate non-plasticized layer 42, which may be referred to, in the instant example, as a non-plasticized layer, and may be configured to provide an inert and/or non-reactive layer sufficient to meet Food and Drug Administration (FDA) or other sensitive chemical contamination requirements. The non-plasticized layer 42 may be co-extrudable and bondable to mating materials, including mating materials comprising the tubing layers adjacent to the flexible layer 42. The non-plasticized layer 42 may be comprised, for example, of a polymeric material which may be bondable to the inner fluoropolymer layer 12 without a plasticizer, such as a thermoplastic elastomer (TPE). In a non-limiting example, the non-plasticized layer can be configured as the second layer 22, and may be defined as a very thin layer to minimize the effect of the overall stiffness of the MLT 10, while expanding the selection of materials bondable to the non-plasticized second layer 22.

In a fifth non-limiting example, an intermediate layer 42 may be configured as a generally translucent or transparent layer for applications where it is important to that the fluid inside the tube be visible or viewable, as for certain medical or food-related application, or to facilitate monitoring of the fluid contained and/or conveyed in the MLT 10. The generally translucent or transparent layer 42 may be co-extrudable with and bondable to the inner fluoropolymer layer 12, which may also be generally translucent to transparent. The other layers comprising the MLT 10 may also be configured to be generally translucent or transparent, such that in combination, the intermediate layer 42 as described in the instant example, the inner layer 12 and the remaining layers define a generally translucent and/or transparent MLT 10. The transparent layer 42 may be comprised, for example, of a polymer selected from a class of polyamide or polyamide containing materials such as certain TPEs. In a non-limiting example, the translucent or transparent layer can be situated as a cover layer 32 or as an intermediate layer 42.

In a sixth non-limiting example, an intermediate layer 42 may be configured as a reinforcement layer, to increase the strength and or durability of the MLT 10 and may be referred to, in the instant example, as a reinforcement layer 42. The reinforcement layer 42 may include one or more different reinforcement layers, each which may be added as a co-extruded tube layer or in a separate process, as required by the configuration and material of the reinforcement layer 42. The reinforcement layer 42 may consist, by way of non-limiting example, of one or more of a uni-axial material layer, a multi-axial material layer including a fabric or textile, a braided or woven material layer, or a metalized layer such as a metal fiber. The thickness of the reinforcement layer 42 may be varied or configured to provide sufficient strength, kink resistant, durability, etc., as required by the application in which the MLT is being used. In a non-limiting example, the reinforcement layer may be situated as a cover layer 32 or as an intermediate layer 42. In a non-limiting example, a uni-axial material layer may be oriented longitudinally to define the reinforcement layer 42, which may improve the longitudinal tubing tensile strength of the MLT 10 while still allowing radial expansion of a section or sections of the MLT 10 for instance, for expansion over a connector such as for a barbed insertion process. A reinforcement layer 42 including uni-axial or multi-axial fibers or fabric or textile layer may be used to improve burst strength while maintaining flexibility of the MLT 10. In another non-limiting example, metalized or metal fiber or foil layer(s) comprising the reinforcement layer 42 may impart strength and other characteristics, such as permeation barrier properties, conductivity and other special properties of metals to the MLT 10. To maintain flexibility, one or more metalized layers 42 may be created from thin metal foils, fibers or tapes which may be applied after a co-extrusion process.

In a seventh non-limiting example, an intermediate layer 42 may be configured as a thermally conductive layer, which may allow the MLT 10 including the thermally conductive layer 42 to transfer heat more effectively than non-conductive tubing. The thermally conductive layer 42 may supplement the primary heat transfer (e.g., the heat transfer effected by the liquid conveyed in and through the MLT 10) when the MLT 10 is configured for use in a liquid cooling application. The supplemental nature of the thermally conductivity provided by the thermally conductive layer 42 of the MLT 10 may reduce system thermal response times and/or dampen temperature fluctuations by adding thermal mass to the system including the MLT 10 or by lowering thermal resistance by utilizing the MLT 10 thus configured for thermal storage and/or dissipation. The thermally conductive layer 42 may accelerate heat transfer away from, for example, a heat generating device operatively connected to the MLT 10. The thermally conductive layer 42 may be co-extrudable and bondable to mating materials, including mating materials comprising the tubing layers adjacent to the thermally conductive layer 42.

In an eighth non-limiting example, an intermediate layer 42 may be configured as an electrically dissipative and/or conductive layer, e.g., the intermediate layer 42 may comprise a conductive element, and may be referred to, in the instant example, as a dissipative/conductive layer, as a dissipative layer, or as a conductive layer 42. The conductive layer 42 may be co-extrudable and/or bondable to mating materials, including mating materials comprising the tubing layers adjacent to the flexible layer 42. The conductive layer 42 may be applied by a secondary process where, by way of non-limiting example, the conductive layer 42 may include a conductive foil applied to a co-extruded tube, may be configured using a flow coating process, or may consist of winding conductive filaments or foil wound around a tube layer or base tube. The electrically conductive layer 42 may be configured with one or more different conductivity levels, where each of the conductivity levels may be suited for a specific function, for example, to support data transfer, enable power transfer, dissipate currents imparted by adjacent electrical components, dissipate static charge build-up, communicate one or more signals, etc.

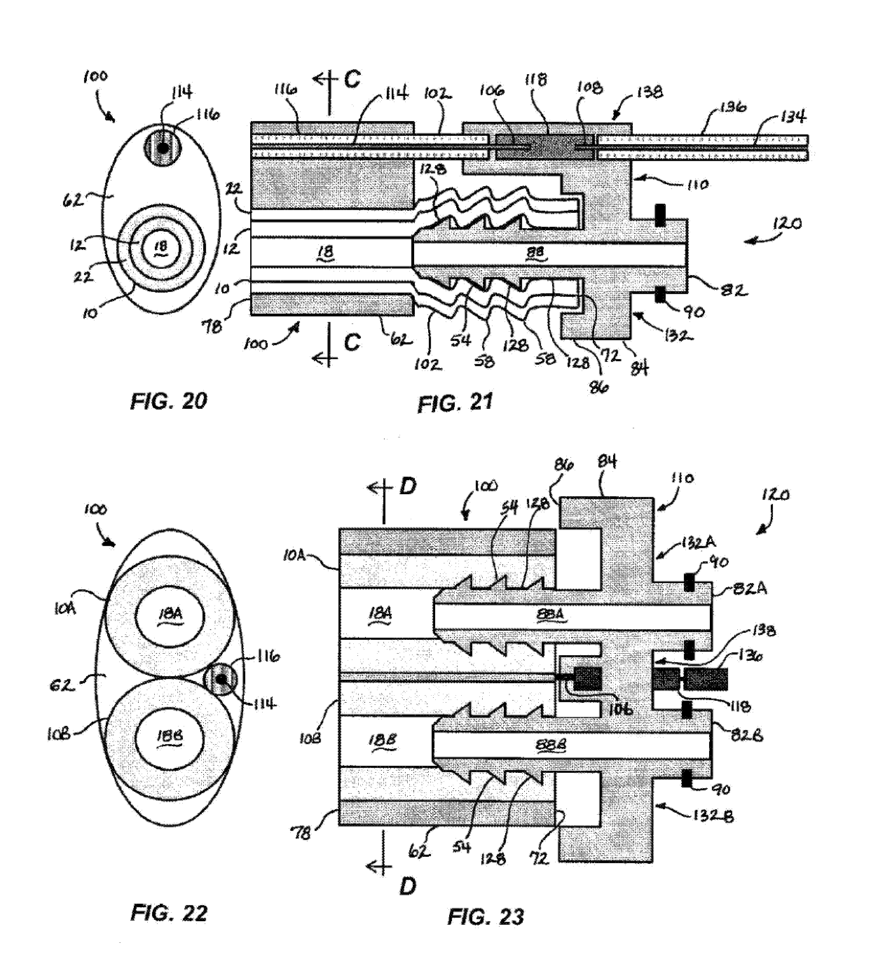

Electrical conductivity may be imparted to the conductive layer 42 through a polymer additive like metal particles, carbon particles, nano-materials or other specialized additives, where such additives are selected so as to not degrade mechanical, chemical, or life characteristics of the MLT 10, or by adding metal or foil layers or fibers to the layer 42, which may require secondary processing of the MLT 10. In a non-limiting example, the conductive or dissipative layer can be situated as an outer or cover layer 32 or as an intermediate layer 42. Additional example configurations of a MLT 10 including a conductive layer are illustrated by and described in further detail related to FIGS. 20-27.

It would be understood that other characteristics and features may be imparted to the MLT 10 by combining a plurality of layers to form or configure the MLT 10, wherein each layer is optimized to contribute one or more specific performance or functional characteristics. In the non-limiting examples provided herein, it is understood that these characteristics or performance features may include flexibility, bondability, thermal conductivity, thermal insulation, electrical conductivity, electrical insulation, inertness, non-reactivity, translucency, transparency, oxygen barrier, nitrogen barrier, and reinforcement or structural characteristics. The number, types, and arrangement of the plurality of layers comprising a MLT 10 is not limited by the examples described herein, and an MLT 10 may be configured to include any number of intermediate layers 42, a cover layer 32 which may include characteristics of an intermediate layer 42, an inner layer 12, and a second layer 22 which may include characteristics of an intermediate layer 42. The thickness, radial arrangement and order, boundary interface or bond configuration of each and between the layers may be varied as required to provide the functional and performance characteristics required and/or specified for a particular application for which the MLT 10 is to be applied. It would be understood that other characteristics may be optimized in one or more of the layers comprising the MLT 10, including, for example, laceration resistance, kink resistance, flame resistance, bondability, twistability, radial flexibility or expansion capability, burst or split resistance, low WVTR, low, flexibility, impact strength, shape (low creep) and thermal stability, chemical and abrasion resistance, resistance to environmental and weatherability (UV, ozone, oxygen) attack, etc. Additionally, one or more characteristics or features may be limited in one layer of a MLT 10 which may be provided by at least one other layer of the MLT 10, such that the layers in combination provide the totality of characteristics defined by each of the layers to the function and performance of the MLT 10.

FIGS. 5 and 6 each show, in non-limiting examples, a schematic cross-sectional illustration of a tube bundle 100 including a plurality of co-axial multi-layer tubes. In a first example configuration shown in FIG. 5, a tube bundle 100 includes a first tube 10A disposed coaxially within a second tube 10B. The first tube 10A may be configured as a MLT as detailed previously, or may be, in a non-limiting example, a monowall tube, which may be comprised of a low cost weldable material. The first tube 10A is defined by an outer surface 76A and an inner surface 74A, wherein the inner surface 74A defines an interior space 18A through which a fluid may be conveyed. The second tube 10B is disposed radially outward of the first tube 10A, such that a second conduit or fluid path 18B is defined between the inner surface 74B of the second tube 10B and the outer surface 76A of the first tube 10A. Accordingly, a first fluid may be conveyed through the first interior space 18A defined by the inner surface 74A of the first tube 10A, and a second fluid may be conveyed through the second interior space 18B defined be the outer surface 76A and the inner surface 76B. In a non-limiting example, the second tube 10B may be configured as a MLT 10B comprising a weldable layer and characterized by a low WVTR. In the instant example, the outer fluid path 18B may be used to transport the lowest temperature fluid of the two respective fluids conveyed through the respective fluid paths 18A, 18B, to reduce fluid permeation from the tube bundle 100. Not shown but understood, the tube bundle may include a cover or outer layer 32, which may be characterized, as described previously, by a flame resistance greater than UL94 HB, or may be configured to improve the impact resistance, abrasion and/or laceration resistance of the tube bundle 100. It would be further understood each of the tubes 10A, 10B, may be configured the same or differently to provide in combination a specific set of characteristics and/or performance features of the tube bundle 100, according to the requirements of the specific application in which the tube bundle 100 is used.

In a second example configuration shown in FIG. 6, a tube bundle 100 includes a first MLT 10A and a second MLT 10B encased in a bundle cover 62. The bundle cover 62 may be made of, for example, an elastomer-based or polymer-based material sufficiently compliant to be molded or formed around the tubes 10A, 10B to form the bundle 100. Each of the tubes 10A, 10B may be configured as described previously, and may be configured the same or differently. In a non-limiting example, the tubes 10A, 10B are characterized by low WVTR. The first tube 10A includes an inner surface 74A, wherein the inner surface 74A defines a fluid pathway or interior space 18A, through which a fluid may be conveyed. The first tube 10A includes an outer surface 76A, which is proximate or in operative contact with the bundle cover 62, such that the first tube 10A is encased in the bundle cover 62. The second tube 10B includes an inner surface 74B, wherein the inner surface 74B defines a fluid pathway or interior space 18B, through which a fluid may be conveyed. The second tube 10B includes an outer surface 76B, which is proximate or in operative contact with the bundle cover 62, such that the second tube 10B is encased in the bundle cover 62. The bundle 100 may be formed, for example, by co-extrusion of the tubes 10A, 10B and the bundle cover 62, or in another non-limiting example, by molding the bundle cover 62 around the tubes 10A, 10B to form the bundle 100. The bundle cover 62 may be operatively attached to the outer surfaces 76A, 76B by mechanical or chemical bonding, or by other suitable means, for example, by an adhesive. Not shown, but understood, a tube bundle 100 may include more than two tubes 10, and the pattern and placement of the tubes in the bundle 100 may be varied.

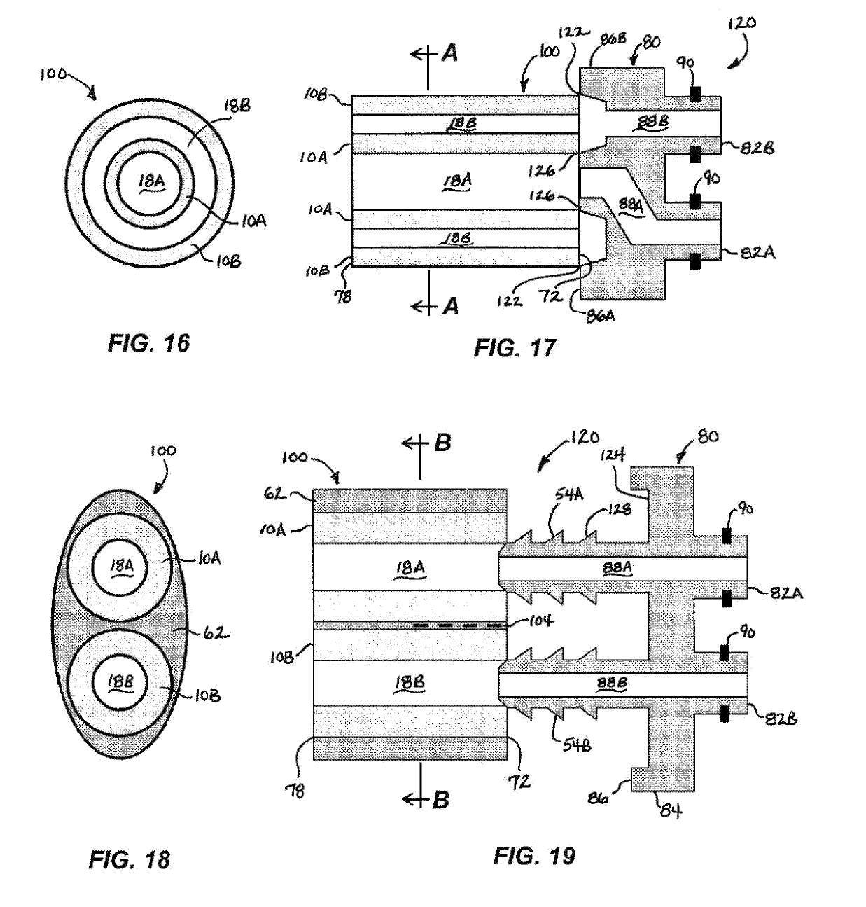

By bundling two or more MLTs 10 together to form a tube bundle 100, as shown in the example configurations of FIGS. 5 and 6, the number of conduits and integrated tube connections required to connect one element or grouping of elements to another element or grouping of elements can be reduced, as described in further detail related to FIGS. 16-19, and the ability to connect multiple MLTs 10 in one operational step, e.g., concurrently, may be enabled, thus reducing assembly time. By forming a tube bundle 100, the packaging space required for the multiple tubes comprising the tube bundle 100 may be significantly reduced. Further, a tube bundle may be configured to incorporate a hermetically sealed joint, or to combine various configurations of tubes 10 in various patterns to optimize the performance characteristics of the tube bundle 100, including permeability and thermal transfer characteristics. Other advantages may include reduced logistics, handling and assembly cost of fluid systems including one or more tube bundles 100.

As shown in the non-limiting examples of FIGS. 20-27, other elements may be bundled with one or more MLTs 10 to form a tube bundle 100. For example, one or more electrically conductive elements 114 (see FIGS. 20-27) may be bundled with one or more MLTs 10 to form a tube bundle 100, such that the tube bundle 100 may be used to convey fluid and an electrical current, which may be in the form of a signal, for example, within a system, thus reducing packaging space and facilitating efficient connection of the fluid and electrical elements of the system.

Further, it would be understood that the configuration of and/or the materials comprising the bundle cover 62 are not limited e.g., the bundle cover 62 may be of any shape suitable for the application in which the tube bundle 100 is used, and may vary in configuration along its length. The bundle cover 62 may comprise multiple layers to provide a combination of performance characteristics to the tube bundle 100, as described for the MLT 10, which may include, for example, abrasion resistance, laceration resistance, reinforcement, kink resistance, etc.

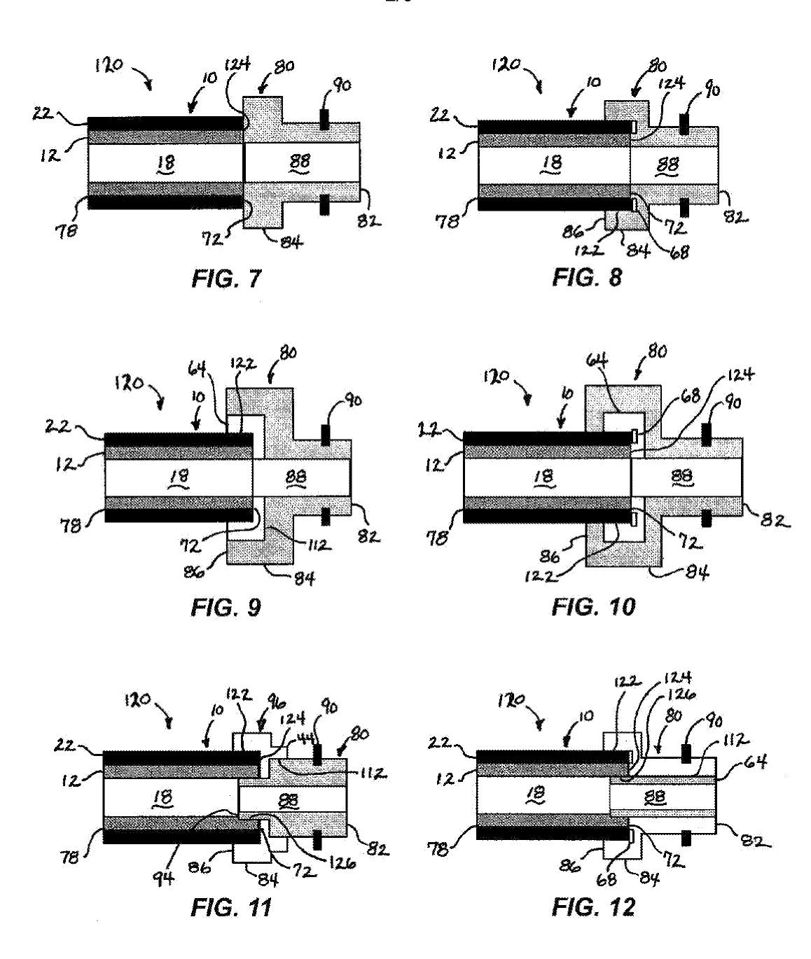

FIGS. 7-15 show, in a series of non-limiting examples, various joining methods and/or connector configurations for tube and joint systems, which may incorporate a MLT 10 as previously described herein to a joining method which provides a welded interface between the MLT 10 and the connector, such that a joint of improved joint robustness, e.g., improved sealing and lower water and/or oxygen permeability, is generated. As described herein, a MLT 10 may be welded to a connector, or to a coupling or insert operatively attached to a connector, by any suitable form of welding, including but not limited to spin welding, ultrasonic (acoustic) welding, vibration welding, hot plate welding, laser welding, etc.). The welded joint formed by welding the MLT 10 to a connector 80 (see FIGS. 7-15) may provide increased resistance to damage and/or leakage, including microleaks, which may result from rotation and/or other manipulation of the joint in use. The welded joint described herein may be formed, for example, by welding or melting materials of the mating components (the MLT 10 and connector 80) to form a bond therebetween. A welded bond, thus formed, may be more robust, for example, than an adhesive bond, as the adhesive bond may degrade with temperature and/or pressure cycling. Further, a welded bond may be used to create a hermetic chemical seal between the polymers comprising the mating components. In a MLT 10, at least one layer may be comprised of a resin or other polymeric material which may be welded to a material comprising the connector 80, or an element such as a coupling or insert operatively attached to the connector 80, to create a, hermetically sealed, welded joint. Another layer of the MLT 10 may comprise a low permeability material, such that in combination, the welded joint formed by the MLT 10 and the connector 80 defines a hermetically sealed, low permeability joint, which may be suitable for applications such as closed loop systems, including closed loop heat transfer applications, bio-medical and food contact applications.

FIGS. 7-15 each show a partial schematic cross-sectional illustration of a multi-layer tube and connector assembly generally indicated at 120. Each assembly 120 includes a MLT 10. For simplicity of illustration, the MLT 10 shown in FIGS. 7-15, and likewise in FIGS. 16-27, is shown or understood to include at least two layers, a first layer 12 defining an internal space or fluid passage 18, and a second layer 22. It would be further understood that a MLT 10 shown in FIGS. 7-27 may include additional layers as described previously, including a cover layer 32 and/or one or more intermediate layers 42, within the scope of this disclosure.

In the non-limiting example shown in FIGS. 7-15 and 20-21, and understood but not shown in FIGS. 16-19 and 22-27, the first layer 12 of the MLT 10 may be a low WVTR layer comprising a fluoropolymer, and the second layer 22 of the MLT 10 may be a bondable and/or weldable layer comprising a polyamide or other bondable/weldable polymer. The connector 80 shown in FIGS. 7-27 may include a low WVTR material such as a liquid crystalline polymer (LCP), such that the joint formed between an interfacing portion of the connector 80 and the MLT 10 may be a low WVTR joint. The connector 80 may be molded, for example, using a two shot molding process, to include an insert 64 or coupling 96, which may comprise a bondable and/or weldable material, such that the MLT 10 may be welded and/or form a bond with the insert 64 and/or coupling 96. The connector 80 shown in FIGS. 7-27 may further include one or more o-rings 90, where the o-rings 90 may be located at the end of the connector 80 distal from the connector end interfacing with the MLT 10, to facilitate sealing of the connector 80 to, for example, an inlet, an outlet or another fluid interface to a device such as a pump, valve, heat exchanger or other device in a fluid carrying system.

Referring again to FIG. 7, shown is a joint assembly 120 including a MLT 10 and a connector 80. The MLT 10 includes a first end 72, and a second end 78 which is distal from the first end 72. As described previously, the MLT 10 includes at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80, which may be molded in a non-limiting example from a low WVTR material includes a body portion 82, also referred to as a body 82 which defines the internal passage 88. The connector 80 further includes a collar portion 84, also referred to as a collar 84. The first end 72 of the MLT 10 is abutted against an interfacing portion of the connector 80, which in the present example is a surface of the collar 84 and welded to form a bonded or welded connection interface 124, which may also be referred to as a butt joint, or a joint interface. Any suitable form of welding, including but not limited to spin welding, ultrasonic (acoustic) welding, vibration welding, hot plate welding, laser welding, etc.) sufficient to weld and/or melt together the materials which are in abutting contact may be used to form the joint interface 124 thus joining the connector 80 to the MLT 10. In a non-limiting example, the bondable layer 22 may be welded and/or joined to the low WVTR material comprising the connector 80. The joint interface 124 thus formed may define at least one of a hermetic and a low WVTR seal between the connector 80 and the MLT 10, and may be characterized by sufficient tensile strength, hoop strength, creep resistance and expandability to provide a reliable (low leak/low permeability) joint.

FIG. 8 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80, which may molded in a non-limiting example from a low WVTR material includes a body 82 which defines the internal passage 88. The connector 80 further includes a collar 84. The collar 84 includes a flange portion 86, which may be referred to as a flange. The flange 86 defines a recess 68 which may also be referred to as a flash trap or trap. The first end 72 of the MLT 10 is inserted or positioned in the flange 86 of the collar 84, and in proximate contact with an interfacing portion of the connector 80, which in the present example is a surface of the flange 86, and proximate to the flash trap 68. The first end 72 is welded to the connector 80 to form a bonded or welded joint, which may consist of a joint interface 122 and another joint interface 124. As described previously, any suitable form of welding sufficient to weld and/or melt together the materials which are in proximate contact may be used to form the joint interfaces 122, 124 thus joining the connector 80 to the MLT 10. In a non-limiting example, the bondable layer 22 may be welded and/or joined to the flange 86 to form a joint interface 122, and the inner layer 12 may be welded and/or joined to the connector 80 to form a joint interface 124. The flash trap 68 may be provided such that any material displaced during the joining (welding operation) may flow into and be contained by the trap 68. The joint formed by one or both of the interfaces 122, 124 may define at least one of a hermetic and a low WVTR seal between the connector 80 and the MLT 10, and may be characterized by sufficient tensile strength, hoop strength, creep resistance and expandability to provide a reliable (low leak/low permeability) joint.

FIG. 9 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80 includes a body 82, which may be molded in a non-limiting example from a low WVTR material, and an insert 64, which may include a bondable material. The body 82 and insert 64 in combination define the internal passage 88. The connector 80 further includes a collar 84 defining a flange portion 86. The flange 86 defines a recess into which an insert 64 is molded and is operatively connected, by bonding or otherwise, to the body 82 of the connector 80 at an interface 112. The insert 64 may be formed in the connector 80, for example, using a two-shot or multiple-shot molding process. The first end 72 of the MLT 10 is inserted or positioned in the insert 64 within the collar 84, and in proximate contact with the insert 64. The first end 72 is welded or bonded to an interfacing portion of the connector 80, which in the present example is a surface of the insert 64, to form a bonded or welded joint between the MLT 10 and the connector 80, which may consist of a joint interface 122. As described previously, any suitable form of welding sufficient to weld and/or melt together the materials which are in proximate contact may be used to form the joint interface 122 thus joining the connector 80 to the MLT 10. In a non-limiting example, the bondable layer 22 may be welded and/or joined to the bondable insert 64 to form a joint interface 122. The joint interface 122 may define at least one of a hermetic and a low WVTR seal between the connector 80 and the MLT 10, and may be characterized by sufficient tensile strength, hoop strength, creep resistance and expandability to provide a reliable (low leak/low permeability) joint.

FIG. 10 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80 includes a body 82, which may be molded in a non-limiting example from a low WVTR material, and an insert 64, which may include a bondable material. The body 82 and insert 64 in combination define the internal passage 88. The connector 80 further includes a collar 84 defining a flange portion 86. The flange 86 defines a recess into which an insert 64 is molded and is operatively connected, by bonding or otherwise, to the body 82 of the connector 80 at an interface 112. The insert 64 may be formed in the connector 80, for example, using a two shot molding process. The insert 64 defines a recess 68 which may also be referred to as a flash trap or trap. The first end 72 of the MLT 10 is inserted or positioned in the flange of the collar 84 and in proximate contact with the insert 64 and flash trap 68. The first end 72 is welded or bonded to the insert 64, to form a bonded or welded joint between the MLT 10 and the connector 80, which may consist of the joint interfaces 122, 124. As described previously, any suitable form of welding sufficient to weld and/or melt together the materials which are in proximate contact may be used to form the joint interfaces 122, 124 thus joining the connector 80 to the MLT 10. In a non-limiting example, the bondable layer 22 may be welded and/or joined to the insert 64 and/or the flange 86 to form a joint interface 122, and the inner layer 12 may be welded and/or joined to the insert 64 to form a joint interface 124. The flash trap 68 may be provided such that any material displaced during the joining (welding operation) may flow into and be contained by the trap 68. The joint formed by one or both of the interfaces 122, 124 may define at least one of a hermetic and a low WVTR seal between the connector 80 and the MLT 10, and may be characterized by sufficient tensile strength, hoop strength, creep resistance and expandability to provide a reliable (low leak/low permeability) joint.

FIG. 11 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80 includes a body 82 defining an extension 94, and may be molded in a non-limiting example from a low WVTR material. The connector 80 further includes a coupling 96, which may include a bondable material. The body 82 and extension 94 define the internal passage 88. The coupling 96 includes a collar 84 defining a flange portion 86. The coupling 96 is operatively connected, by bonding or otherwise, to the body 82 of the connector 80 at an interface 112. The coupling 96 may be molded in conjunction with the body 82 to form the connector 80, for example, using a two-shot or multiple-shot molding process. The first end 72 of the MLT 10 is inserted or positioned in the coupling 96 within the collar 84, and in proximate contact with the extension 94. The first end 72 is welded or bonded to the coupling 96 and/or the extension 94, to form a bonded or welded joint between the MLT 10 and the connector 80, which may consist of one or more of the joint interfaces 122, 124, 126. As described previously, any suitable form of welding sufficient to weld and/or melt together the materials which are in proximate contact may be used to form the joint interfaces 122, 124, 126 thus joining the connector 80 to the MLT 10. In a non-limiting example, the bondable layer 22 may be welded and/or joined to the bondable coupling 96 to form the joint interface 122. The inner layer 12 may be welded and/or joined to the bondable coupling 96 to form the joint interface 124, and may be welded and/or joined to the extension 94 to form the joint interface 126. The joint interfaces 122, 124, 126 may each or in combination define at least one of a hermetic and a low WVTR seal between the connector 80 and the MLT 10, and may be characterized by sufficient tensile strength, hoop strength, creep resistance and expandability to provide a reliable (low leak/low permeability) joint.

FIG. 12 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80 includes a body 82, which may be molded in a non-limiting example from a bondable material, and an insert 64, which may be molded from a low WVTR material. The low WVTR insert 64 is configured to define the internal passage 88, which may be characterized by low permeability. The insert 64 is operatively connected, by bonding or otherwise, to the body 82 of the connector 80 at an interface 112. The insert 64 may be formed in the connector 80, for example, using a two shot molding process. The connector 80 further includes a collar 84 defining a flange portion 86 made from a bondable material. The flange portion 86 and the insert 64 in combination define a generally annular opening into which the first end 72 of the MLT 10 is inserted or positioned in proximate contact with the insert 64, the flange 86, and a flash trap 68 defined by the flange 86. The first end 72 of the MLT 10 is welded or bonded to the insert 64 and/or the bondable flange 86, to form a bonded or welded joint between the MLT 10 and the connector 80, which may consist of the joint interfaces 122, 124, 126. As described previously, any suitable form of welding sufficient to weld and/or melt together the materials which are in proximate contact may be used to form the joint interfaces 122, 124, 126 thus joining the connector 80 to the MLT 10. In a non-limiting example, the bondable layer 22 may be welded and/or joined to the bondable flange 86 to form a joint interface 122, and the inner layer 12 may be welded and/or joined to the bondable flange 86 and the insert 64 to form, respectively, the joint interfaces 124, 126. The flash trap 68 may be provided such that any material displaced during the joining (welding operation) may flow into and be contained by the trap 68. The joint formed by one or a combination of the interfaces 122, 124, 126 may define at least one of a hermetic and a low WVTR seal between the connector 80 and the MLT 10, and may be characterized by sufficient tensile strength, hoop strength, creep resistance and expandability to provide a reliable (low leak/low permeability) joint.

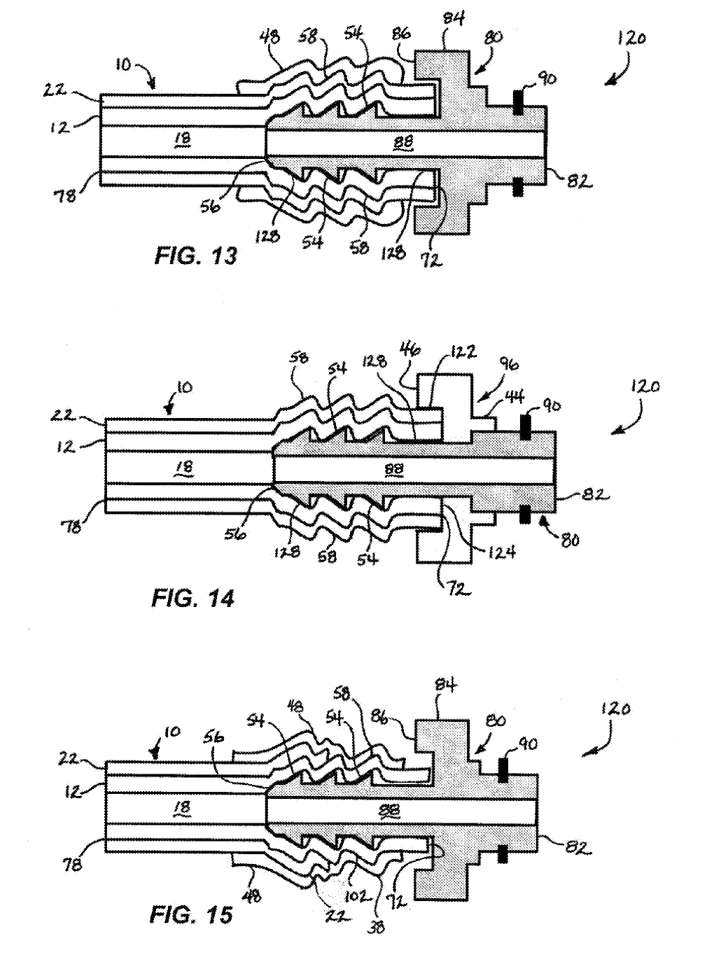

FIG. 13 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80, which may be molded in a non-limiting example from a low WVTR material, includes a body 82 which defines the internal passage 88. The connector 80 further includes a collar 84 defining a flange 86. As shown in FIG. 13, the first end 72 of the MLT 10 may also be positioned in proximate contact with the collar 84. The body 82 further defines a nose portion 56 and a plurality of barbs 54 formed on the surface of the nose portion 56. The plurality of barbs 54 are distributed radially and axially on the nose portion 56 and configured such that when the first end 72 of the MLT 10 is inserted over the nose portion 56 and the barbs 54 to be positioned in proximate contact with the collar 84 and flange 86, the inner surface 14 (see FIG. 1) of the MLT 10 is retained by the barbs 54 and in operative contact with the connector 80 to define one or more joint interfaces 128. The barbs 54 may be rounded or sharp, depending on the application, and may be configured to define a standard double or triple barb connection, as those references would be understood. One or more of the layers of the MLT 10, which may include, for example, the inner layer 12, the second layer 22, an intermediate layer 42 not shown in FIG. 13, and/or cover layer 32 not shown in FIG. 13, may be configured to provide a combination of tensile strength, hoop strength, creep resistances, expandability, which may be defined by elongation greater than 150%, such that the MLT 10 may be expanded over the barbs 54 to provide a distorted portion 58, which is distorted to comply with, e.g., to be in proximate contact with, at least a portion of the surface of one or more of the barbs 54 to define one or more joint interfaces 128. The MLT 10 may have sufficient expandability and recovery properties such that end portion 72, after expansion over the barbs 54, may sufficiently recover its pre-expansion configuration to make proximate contact with collar portion 84 and adjacent body portion 82 of the connector 80. The respective surface or a portion thereof of one or more of the barbs 54, the collar 84, the flange 86 and and body 82 may provide an interfacing portion of the connector 80, to define one or more joint interfaces. As shown in FIG. 14, the first end 72 of the MLT 10 may also be welded to the body 82 and/or to the collar 84 of the connector 80 to form a bonded or welded joint interface 124. As described previously, any suitable form of welding sufficient to weld and/or melt together the materials which are in proximate contact may be used to form the joint interface 124 thus joining the connector 80 to the MLT 10. In a non-limiting example, the bondable layer 22 may be welded and/or joined to the low WVTR material comprising the connector 80. One or more of the joint interfaces 124, 128 thus formed may define at least one of a hermetic and a low WVTR seal between the connector 80 and the MLT 10, and may be characterized by sufficient tensile strength, hoop strength, creep resistance and expandability to provide a reliable (low leak/low permeability) joint. The joint assembly 120 may further include a retaining element 48, which may be configured to be positioned over the distorted portion 58 before or after the MLT 10 is expanded over the barbs 54. The retaining element 48 may be configured as a generally annular member, which may be made from, by way of non-limiting example, a metal-based or polymer based material or a combination thereof. The retaining element 48 may also be referred to as a sleeve, a sleeve fitting, or as a wedding band, as that term is commonly understood. The retaining element 48 may be configured to substantially cover or encase the distorted portion 58 so as to provide a pressure or force to facilitate retaining the distorted portion 58 in proximate contact with the barbs 54, such that a sealing contact is maintained therebetween. The retaining sleeve 48 may be retained in position over the distorted portion 58, for example, by one or a combination of a press-fit, shrink-fit, adhesive, crimping, or clamping force.

FIG. 14 shows another configuration of a joint assembly 120 including a MLT 10 and a connector 80. As described for FIG. 7, the MLT 10 includes a first end 72, and a second end 78 distal from the first end 72, at least a first layer 12, which may be a low WVTR layer, and a second layer 22, which may be a bondable or weldable layer. The first layer 12 defines an interior passage 18 in communication with an internal passage 88 defined by the connector 80, such that a fluid (not shown) may be conveyed from one to the other of the passages 18 and 88. The connector 80, which may be molded in a non-limiting example from a low WVTR material, includes a body 82 which defines the internal passage 88. The connector 80 further includes a coupling 96, which may include a bondable material. The coupling 96 includes a collar 44 and a flange portion 46. The coupling 96 is operatively connected, by bonding or otherwise, to the body 82 of the connector 80. The coupling 96 may be molded in conjunction with the body 82 to form the connector 80, for example, using a two shot molding process. The body 82 further defines a nose portion 56 and a plurality of barbs 54 formed on the surface of the nose portion 56.

The plurality of barbs 54 are distributed radially and axially on the nose portion and configured such that when the first end 72 of the MLT 10 is inserted over the nose portion 56 and the barbs 54 to be positioned in proximate contact with the collar 84 and flange 86, the inner surface 14 (see FIG. 1) of the MLT 10 is retained by the barbs 54 and in operative contact with the connector 80 to define one or more joint interfaces 128. The barbs 54 may be configured to define a standard double or triple barb connection, as those references would be understood. One or more of the layers of the MLT 10, which may include, for example, the inner layer 12, the second layer 22, an intermediate layer 42 not shown in FIG. 13, and/or cover layer 32 not shown in FIG. 13, may be configured to provide a combination of tensile strength, hoop strength, creep resistances, expandability, which may be defined by elongation greater than 150%, such that the MLT 10 may be expanded over the barbs 54 to provide a distorted portion 58, which is distorted to comply with, e.g., to be in proximate contact with, at least a portion of the surface of one or more of the barbs 54 to define one or more joint interfaces 128.

The MLT 10 may have sufficient expandability and recovery properties such that end portion 72, after expansion over the barbs 54, may sufficiently recover its pre-expansion configuration to make proximate contact with coupling 96 and adjacent body portion 82 of the connector 80. The first end 72 of the MLT 10 is inserted or positioned in a generally annular recess defined by the coupling 96 and the body 82, such that the first end 72 of the MLT 10 is in proximate contact with the flange portion 46 of the coupling 96 and the inner surface 14 (see FIG. 1) of the MLT 10 adjacent to the first end 72 is in proximate contact with the body 82. The first end 72 is welded or bonded to the coupling 96 and/or the flange 94, to form one or more bonded or welded joints between the MLT 10 and the connector 80, which may consist of one or more of the joint interfaces 122, 124. The first end 72 of the MLT 10 may also be welded to the body 82 of the connector 80 to form a bonded or welded joint interface 128. As described previously, any suitable form of welding sufficient to weld and/or melt together the materials which are in proximate contact may be used to form the joint interfaces 122, 124, 128 thus joining the connector 80 to the MLT 10. In a non-limiting example, the bondable layer 22 may be welded and/or joined to the bondable material of the coupling 96 and/or to the low WVTR material comprising the connector 80. One or more of the joint interfaces 122, 124, 128 thus formed may define at least one of a hermetic and a low WVTR seal between the connector 80 and the MLT 10, and may be characterized by sufficient tensile strength, hoop strength, creep resistance and expandability to provide a reliable (low leak/low permeability) joint 120.

FIG. 15 shows another configuration of a joint assembly 120 including, by way of non-limiting example, a MLT 10 and a connector 80, as generally described for FIG. 13, configured to reduce the effects of material creep on joint integrity whereby the one or more of the outer and intermediate layers 32, 42 have been removed from the end of the MLT 10 to provide a modified portion 102, and the inner layer 12 is reinforced and/or supported by a retaining element 48. The retaining element 48 may be generally shaped as a band, which may be tapered or stepped. The retaining element 48 may be made of a low creep material. As shown in FIG. 15, the the modified portion 102 is defined by a length of the MLT 10 where the intermediate and/or outer layer(s) 32, 42 of the MLT 10, which as shown in FIG. 15 comprise the layer 22, are not present or have been removed such that only the inner layer 12 remains to define the first end portion 72 of the MLT 10. The MLT 10 may be formed, for example, during the extrusion process, to provide the modified portion 102 with the outer layer(s) not present. The modified portion 102 may be provided, for example, by removing one or more layers 32, 42 from the MLT 10, for example, by a mechanical or chemical stripping process. The configuration of the joint assembly 120 as shown in FIG. 15 may be suitable, by way of non-limiting example, to remove outer and/or intermediate layer(s) which may exhibit creep and/or compression setting and reduce joint integrity over time from the MLT 10, and to facilitate expansion of the remaining inner layer 12 over the barbs 24. It would be understood that the modified portion 102 may consist of a single inner layer 12, or may consist of multiple layers comprising an inner layer 12. It would be further understood that the modified portion 102 may consist of the inner layer 12 and at least one other layer, as require by the specific application, connector 80, and configuration of the MLT 10. The modified portion 102 may also be referred to herein as the stripped portion, wherein used of the term “stripped” is not intended to be limiting.

As described previously for FIGS. 13 and 14, the joint assembly 120 of FIG. 15 may provide a sealing interface 128 (see FIGS. 13 and 14) between the inner layer 12 and one or more of the barbs 54 and the body portion 82 of the connector 80, and may further provide a sealing interface 124 (see FIG. 14) between the first end 72 and the coupling 96. As shown in FIG. 14, the MLT 10 is inserted over the nose portion 56 and the barbs 54 such that the inner surface 14 (see FIG. 1) of the MLT 10 is retained by the barbs 54 and in operative contact with the connector 80 to define one or more joint interfaces 128. One or more of the layers of the MLT 10, which may include, by way of non-limiting example, the second layer 22, an intermediate layer 42 not shown in FIG. 14, and/or cover layer 32 not shown in FIG. 14, may be removed to provide the modified portion 102 characterized by sufficient expandability, recovery and flexibility, such that the MLT 10 may be expanded over the barbs 54 to provide the distorted portion 58, as described previously for FIG. 13, and to sufficiently recover its pre-expansion configuration to make proximate contact with collar portion 84 and adjacent body portion 82 of the connector 80.

As described for FIG. 14, the first end 72 may be welded to the body 82 and/or to the collar 84 of the connector 80 to form a bonded or welded joint interface 124. As described previously, any suitable form of welding sufficient to weld and/or melt together the materials which are in proximate contact may be used to form the joint interface 124 thus joining the connector 80 to the MLT 10. In a non-limiting example, the low WVTR layer 12 may be welded and/or joined to the low WVTR material comprising the connector 80. One or more of the joint interfaces 124, 128 thus formed may define at least one of a long life, hermetic and a low WVTR seal between the connector 80 and the MLT 10, and may be characterized by sufficient tensile strength, hoop strength, creep resistance and expandability to provide a reliable (low leak/low permeability) joint 120. The joint assembly 120 may further include a retaining element 48, which may be configured to be positioned over the distorted portion 58 before or after the MLT 10 is expanded over the barbs 54. The retaining element 48 may be configured to reinforce the inner tubing layer 12 defining the modified section 102 and a section of the adjacent unstripped MLT 10 extended over the barbs 54. The joint (seal) provided by this configuration may exhibit higher robustness and reliability, longer life, lower permeation and lower leakage.

The retaining element 48 may be configured as a generally annular member, and may be made from, by way of non-limiting example, a metal-based or low creep polymer based material or a combination thereof. The retaining element 48 may also be referred to as a sleeve, a sleeve fitting, or as a wedding band, as that term is commonly understood. The retaining element 48 may be configured to substantially cover or encase the distorted portion 58 so as to provide a pressure or force to facilitate retaining the distorted portion 58 in proximate contact with the barbs 54, such that a sealing contact is maintained therebetween. The distorted portion 58 may comprise a portion of the modified or stripped length 102, and an unmodified (unstripped) portion of the MLT 10, as shown in FIG. 15. The retaining sleeve 48 may be retained in position over the distorted portion 58, for example, by one or a combination of a press-fit, shrink-fit, adhesive, crimping, or clamping force, and/or may be configured, in a non-limiting example, with a tapered or stepped portion 38 to provide additional pressure and/or sealing force concurrently on the modified portion 102 and on the adjacent unmodified portion of the MLT 10 substantially reinforcing the modified section, the portion of the unmodified section of the MLT 10 positioned over the underlying barb 54, and the transition portion therebetween.

FIGS. 16-27 show various configurations of a joint assembly 120 including a tube bundle 100, wherein more than one fluid and/or electrical connection is integrated into a single joint assembly 120. In FIGS. 20-27, the tube bundle 100 is shown including at least one electrically conductive element 114, such that the joint assembly 120 may be used to concurrently join one or more fluid interfaces and/or one or more electrical connections (circuits) to a device such as, and by way of non-limiting example, a pump, valve, heat exchanger or other device in a fluid carrying system which may be electrically powered or controlled by an electrical signal. Advantages of such a configuration include the ability to make (connect or disconnect) multiple joints at one time, to control the configuration and/or orientation of multiple tubes and/or electrical joints in mating components, reduce connection and/or disconnection time, reduce packaging space and/or improve packaging efficiency, etc. Each of these configurations is intended to be non-limiting, and other configurations and combinations are possible.

FIG. 16 is a schematic illustration of cross-section A-A of FIG. 17, showing a tube bundle 100 which may be configured as described for FIG. 5, including a first tube 10A is disposed coaxially within a second tube 10B. The first tube 10A may be configured as a MLT as detailed previously, or may be, in a non-limiting example, a monowall tube, which may be comprised of a low cost weldable material. The first tube 10A defines an interior space 18A through which a fluid may be conveyed. The second tube 10B disposed radially outward of the first tube 10A, such that a second conduit or fluid path 18B is defined between the inner surface of the second tube 10B and the outer surface of the first tube 10A. Accordingly, a first fluid may be conveyed through the first interior space 18A, and a second fluid may be conveyed through the second interior space 18B. In a non-limiting example, the second tube 10B may be configured as a MLT 10B comprising a weldable layer and characterized by a low WVTR. Not shown but understood, the tube bundle may include a cover or outer layer 32, which may be characterized, as described previously, by a flame resistance greater than UL94 HB, or may be configured to improve the impact resistance, abrasion and/or laceration resistance of the tube bundle 100. It would be further understood that each of the tubes 10A, 10B, may be configured the same or differently to provide in combination a specific set of characteristics and/or performance features of the tube bundle 100, according to the requirements of the specific application in which the tube bundle 100 is used.

FIG. 17 is a partial schematic cross-sectional illustration of a tube bundle and connector assembly, also referred to as a joint assembly 120. The joint assembly 120 includes a connector 80 and a tube bundle 100, for example, the tube bundle 100 of FIG. 16. The tube bundle 100 may be configured as described for FIG. 16 including a first tube 10A and a second tube 10B, and further defines a first end 72, and a second end 78 which is distal from the first end 72. The connector 80, which may be molded in a non-limiting example from a low WVTR material, includes a body 82 which is generally configured in two portions, a first body portion 82A and a second body portion 82B. The first body portion 82A defines an interior passage 88A. When joined to form the joint assembly 120, the interior passage 88A may be in fluid communication with the interior passage 18A of the first tube 10A. The second body portion 82B defines an interior passage 88B including a generally annular portion. When joined to form the joint assembly 120, the generally annular portion of the interior passage 88B may be in fluid communication with the interior passage 18B defined by the outer surface of the first tube 10A and the inner surface of the second tube 10B. The connector body 82 includes a flange portion 86B defining the generally annular portion of the interior passage 88B, as shown in FIG. 17. The first end 72 of the tube bundle 100 is abutted against the flange face 86A of the connector 80 and welded or bonded to form connection interfaces 122, 126, which may also be referred to as joint interfaces. As shown in FIG. 17, the first end 72 of the first tube 10A is welded or bonded to the flange face 86A to form the first connection interface 126, thus joining the connector passage 88A of the connector 80 in fluid communication with the passage 18A of the first tube 10A. The first end 72 of the second tube 10B is welded or bonded to the flange face 86A to form the second connection interface 122. The first and second connection interfaces 126, 122 join the generally annular portion of the connector passage 88B in fluid communication with the passage 18B of the tube bundle 100. The first connection interface 126 is further configured to seal the passage formed by passages 18A, 88A from the passage formed by passages 18B, 88B, such that the fluid conveyed and/or contained in the passage 18A/88A is kept separated from the fluid conveyed and/or contained in the passage 18B/88B, e.g., is configured to be resistant to any fluid leakage between the passage defined by 18B, 88B and the passage defined by 18A, 88A, after welding the tube bundle 100 to the connector 80. The joint interfaces 122, 126 thus formed may define at least one of a hermetic and a low WVTR seal between the connector 80 and the respective tubes 10B, 10A, and may be characterized by sufficient tensile strength, hoop strength, creep resistance and expandability to provide reliable (low leak/low permeability) joints. Any suitable form of welding, including but not limited to spin welding, ultrasonic (acoustic) welding, vibration welding, hot plate welding, laser welding, etc.) sufficient to weld and/or melt together the materials which are in abutting contact may be used to form the joint interfaces 122, 126.

FIG. 18 is a schematic illustration of cross-section B-B of FIG. 19 showing a tube bundle 100 which may be configured as described for FIG. 6, including a first MLT 10A and a second MLT 10B encased in a bundle cover 62. The bundle cover 62 may be made of, for example, an elastomer-based or polymer-based material sufficiently compliant to be molded or formed around the tubes 10A, 10B to form the bundle 100. Each of the tubes 10A, 10B may be configured as described previously, and each tube 10A, 10B may be configured the same as or differently from the other. In a non-limiting example, the tubes 10A, 10B are encased in the bundle cover 62, and each of the tubes 10A, 10B may be characterized by low WVTR. The first tube 10A defines a fluid pathway or interior space 18A, through which a fluid may be conveyed, and the second tube 10B defines a fluid pathway or interior space 18B, through which a fluid may be conveyed.

FIG. 19 is a partial schematic cross-sectional illustration of a tube bundle 100 adjacent to a barbed connector 80, such that when assembled as generally shown in FIG. 14, the bundle 100 and connector 80 together form a joint assembly generally indicated at 120. The joint assembly 120 thus formed includes the connector 80 and the tube bundle 100, which may be, for example, the tube bundle 100 of FIG. 18. The tube bundle 100 may be configured as described for FIG. 18 including a first tube 10A and a second tube 10B, and further defines a first end 72, and a second end 78 distal from the first end 72. The connector 80, which may be molded in a non-limiting example from a low WVTR material, includes a body 82 which is generally configured in two portions, a first body portion 82A and a second body portion 82B. The first body portion 82A defines an interior passage 88A. The first body portion 82A further defines a plurality of barbs 54A, as previously described related to FIGS. 13-15. When the first tube 10A is joined to the first body portion 82A to form the joint assembly 120, the interior passage 88A is in fluid communication with the interior passage 18A of the first tube 10A. The second body portion 82B defines an interior passage 88B. The second body portion 82B further defines a plurality of barbs 54B, as previously described related to FIGS. 13-15. When the second tube 10B is joined to the second body portion 82B to form the joint assembly 120, the interior passage 88B is in fluid communication with the interior passage 18B of the second tube 10B. The connector 80 further includes a collar 84 defining a flange 86. Referring now to FIGS. 14 and 19, it would be understood that the first end 72 of the tube bundle 100 may be positioned in proximate contact with the collar 84 by concurrently inserting the interior passage 18A of the first tube 10A over the barbed section 54A while inserting the interior passage 18B of the second tube 10B over the barbed section 54B of the connector 80, until the first end 72 of the tube bundle is in proximate contact with the collar 84 and flange 86. The bundle cover 62 may be separated, e.g., may be cut or split, as generally indicated at 104 in FIG. 19, to facilitate assembly of the tube bundle 100 to the connector 80, and/or to allow for distortion of the tubes 10A, 10B (see 58 in FIG. 14) as each is inserted over a respective barbed portion 54A, 54B. When assembled to form the joint assembly 120, the inner surface 14 (see FIG. 1) of each respective tube 10A, 10B is retained by the respective set of barbs 54A, 54B as described for FIG. 14, to provide one or more joint interfaces 128 (see also FIG. 14). The barbs 54A and 54B may be configured to define a standard double or triple barb connection, as those references would be understood. Each of the tubes 10A, 10B may be configured, as described for FIGS. 13-15, to provide a combination of tensile strength, hoop strength, creep resistances, expandability, which may be defined by elongation greater than 150%, such that each tube 10A, 10B may be expanded over a respective plurality of barbs 54A, 54B to provide a respective distorted portion 58 (see FIG. 14.), which is distorted to comply with, e.g., to be in proximate contact with, at least a portion of the surface of one or more of the retaining barbs 54 to define one or more joint interfaces 128. Each of the tubes 10A, 10B may have sufficient expandability and recovery properties such that end portion 72 of the tube bundle 100, after expansion over the barbs 54A, 54B, may sufficiently recover its pre-expansion configuration to make proximate contact with collar portion 84 and adjacent body portion 82 of the connector 80. Referring now to FIG. 14, is would be understood that the first end 72 of the tube bundle 100 may also be welded to the body 82 and/or to the collar 84 of the connector 80 to form a bonded or welded joint interface 124. As described previously, any suitable form of welding sufficient to weld and/or melt together the materials which are in proximate contact may be used to form the joint interface 124 thus joining the connector 80 to the tube bundle 100. In a non-limiting example, a bondable material of one or more of the tubes 10A, 10B, and/or the bundle cover 62 may be welded and/or joined to the low WVTR material comprising the connector 80. One or more of the joint interfaces 124, 128 thus formed may define at least one of a hermetic and a low WVTR seal between the connector 80 and the tubes 10A, 10B and/or between the connector 80 and the tube bundle 100, and may be characterized by sufficient tensile strength, hoop strength, creep resistance and expandability to a reliable (low leak/low permeability) joint assembly 120.

FIG. 20 is a schematic illustration of cross-section C-C of FIG. 21; showing a tube bundle 100 which may include a tube 10 and an electrically conductive element 114, which may be encased, in a non-limiting example, in a cover 116, which may be an insulating cover. The tube 10 which may be configured as a MLT as detailed previously, including at least a inner layer 12 and a second layer 22, and defining an interior space 18 through which a fluid may be conveyed. In a non-limiting example (not shown) the tube 10 may be configured as a monowall tube, which may be comprised of a low cost weldable material, a plastic or polymeric material, and/or as a rubber tube. Not shown but understood, the tube bundle 100 may include a cover or outer layer 32, which may be characterized, as described previously, by a flame resistance greater than UL HB94, or may be configured to improve the impact resistance, abrasion and/or laceration resistance of the tube bundle 100. The bundle 100 may be formed, for example, by co-extrusion or cross-head extrusion of the tube 10, the conductive element 114 (with or without the cover 116), and the bundle cover 62, or in another non-limiting example, by molding the bundle cover 62 around the tube 10 and the conductive element 114 (with or without the cover 116) to form the bundle 100. The bundle cover 62 may be operatively attached to the outer surfaces of the tube 10 and the conductive element 114 and/or cover 116 by mechanical or chemical bonding, or by other suitable means, for example, by an adhesive. The electrically conductive element 114 may be a wire, a conductive filament, or other conductive element, and may be configured to conduct an electrical current, sense and/or communicate one or more electrical or magnetic signals, etc.

FIG. 20 is a partial schematic cross-sectional illustration of the joint assembly 120 shown in FIG. 21, including a tube bundle 100, such as the tube bundle shown in FIG. 19, operatively connected to a connector assembly 110. The connector assembly 110 includes a fluid connector portion 132 and an electrical connector portion 138, and may molded in a non-limiting example from a low WVTR material, wherein the electrical connector portion 138 may include an insert, such as the electrical connector 118. The joint assembly 120 may be assembled such that an electrical connection is formed between an electrically conductive element 114 of the tube bundle 100 and an electrically conductive element 134, which may be, in a non-limiting example, operatively connected with an electrically powered device such as a fan or pump, via an electrical connector 118 included in the connector assembly 110. The joint assembly 120 thus assembled further provides a fluid connection between an interior passage 18 defined by the tube 10 of the tube bundle 100 and an interior passage 88 defined by the body 18 of a fluid connector portion 132 of the connector assembly 110.

The tube bundle 100 may further define a first end 72, and a second end 78 distal from the first end 72. The tube 10 may be configured as a MLT 10, including at least an inner layer 12 and a second layer 22, as previously described. The tube bundle 100 may be configured such that a portion of the bundle cover 62 may be removed from the first end 72, to provide a stripped portion 102 comprising a portion of the conductive element 114 and cover 116 and a portion of the tube 10 in an unbundled arrangement, to facilitate connection of the conductive element 114 to the electrical connector portion 138 and connection of the tube end 72 to the fluid connector portion 132, which in the present example is a barbed connector and/or to allow for distortion of the tube 10 (see 58 in FIG. 19) as it is inserted over the barbed portion 54. Additionally, a portion of the insulating cover 116 may be removed from the end of the conductive element 114 to provide a stripped portion 106, to facilitate electrical connection with/into the electrical connector 118. An electrical connection may be established between the tube bundle 100, and a device (not shown), such as a pump or a fan, operatively connected to the electrically conductive element 134 via the electrical connector 118. The conductive element 134 may be configured with an insulating cover 136, which may be partially removed to provide a stripped portion 108 of the conductive element 134. The stripped portions 106 and 108 may be operatively connected to the electrical connector 118, to establish an electrical connection between the tube bundle 100 and the device.

As described previously related to FIGS. 14 and 19, a fluid connection may be established between the tube bundle 100 and the connector assembly 110, by joining stripped portion of the tube 10 to the fluid connector portion 132, for example, by inserting the first tube end 72 over the barbs 54 such that the tube end 72 is in proximate contact with the collar 84 and/or flange 86, and such that the interior passage 88 is in fluid communication with the interior passage 18. When assembled to form the joint assembly 120, the inner surface 14 (see FIG. 1) of the tube 10 is retained by the plurality of barbs 54 as described for FIG. 14, to provide one or more joint interfaces 128. The first end 72 of the tube bundle 100 may also be welded to the body 82 and/or to the collar 84 of the connector 132 to form a bonded or welded joint interface 124 as shown in FIG. 14. One or more of the joint interfaces 124, 128 thus formed may define at least one of a hermetic and a low WVTR seal between the connector 132 and the tube 10.

Bundling at least one tube 10 and at least one electrically conductive element 114 together in a tube bundle 100 allows a reduction in the number of conduits and/or wires in a system. Similarly, bundling at least one fluid connector 132 and at least one electrical connector 138 in a connector assembly 110 allows a reduction in the number of connectors in a system. Additional advantages of this type of tube bundle and joint assembly arrangement may include a reduced number of fluid and/or electrical joints, reduced wiring in fluid systems requiring electrical devices (pumps, fans, valves, etc.), reduced logistics, handling and assembly cost of fluid and electrical systems, reduced assembly (connect/disconnect) time, improved routing and packaging of fluid and electrical conduits, improved stability and retention of tubes and/or circuits (wires) in a system, etc. The conductive element 114, which may be configured, in non-limiting examples, as shown in FIGS. 20-21, as shown in and described for FIGS. 26-27, or in other configurations including but not limited to strips, ribbons, filaments, coatings, and/or foils which may be included in a tube bundle 100, may be used to sense (detect, monitor, actuate) electrical operation, transfer information (data, signals) and/or conduct electricity.

FIGS. 22-23 show another non-limiting example of a joint assembly 120 including a tube bundle 100 and a connector assembly 110. FIG. 22 shows a cross-sectional illustration of the tube bundle 100 of FIG. 23, which includes a first tube 10A, a second tube 10B, an electrically conductive element 114, which in a non-limiting example is encased by an insulating layer or cover 116, and a bundle cover 62, each of which may be configured as previously described to form the tube bundle 100. A connector 132, which may molded in a non-limiting example from a low WVTR material, includes a first connector portion 132A having a first body portion 82A and a second connector portion 132B having a second body portion 82B. The first body portion 82A defines an interior passage 88A and a plurality of barbs 54. When the first tube 10A is joined to the first body portion 82A to form the joint assembly 120, the interior passage 88A is in fluid communication with the interior passage 18A of the first tube 10A. The second body portion 82B defines an interior passage 88B and a plurality of barbs 54, as previously described. When the second tube 10B is joined to the second body portion 82B to form the joint assembly 120, the interior passage 88B is in fluid communication with the interior passage 18B of the second tube 10B. The connector 132 further includes a collar 84 defining a flange 86. The first end 72 of the tube bundle 100 may be positioned in proximate contact with the collar 84 and the flange 86. The bundle cover 62 may be separated, e.g., may be cut or split as generally described for FIG. 19, to separate the tubes 10A, 10B from each other and from the conductive element 114, to facilitate assembly of the tubes 10A, 10B to the respective barbed portions, and/or to allow for distortion of the tubes 10A, 10B (see 58 in FIG. 14) as each is inserted over a respective barbed portion 54, and to facilitate insertion of the conductive element 114 into the electrical connector 118. A portion of the bundle cover 62 and the insulating cover 116 may be removed to provide a stripped portion 106 of the conductive element 114, as described for FIG. 21. Also as described for FIG. 21, the conductive element 114 may be electrically connected to a device including a conductive element 134 (shown in FIG. 23 enclosed in an insulating cover 136) via an electrical connector 118 operatively attached to the electrical connector portion 138 of the connector assembly 110.

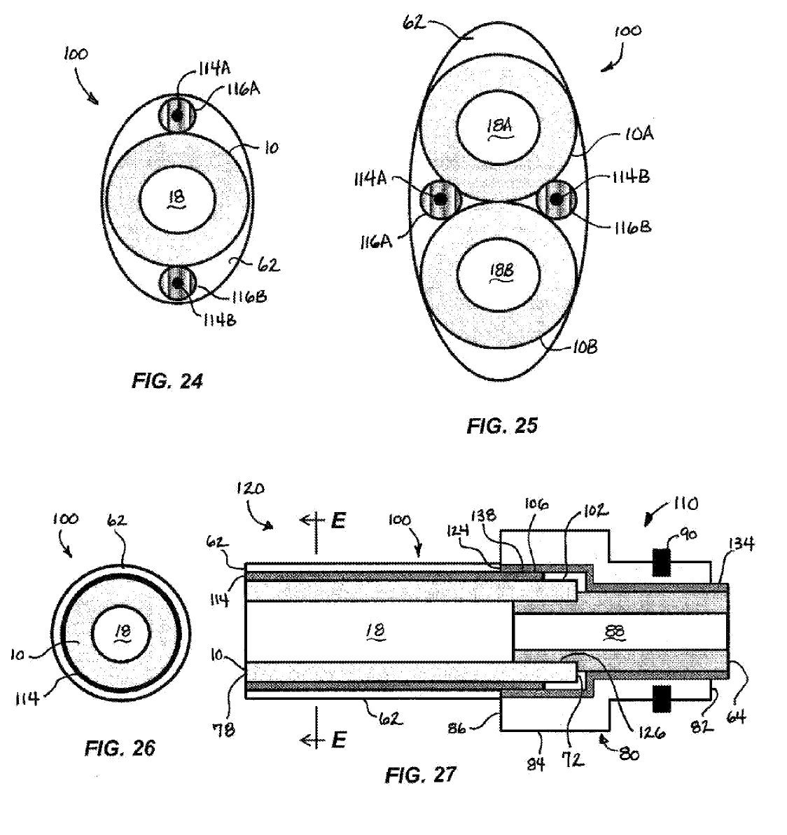

As shown in FIGS. 24, 25, a tube bundle 100 may include more than one tube 10 and/or more than one conductive element 114, and the type, pattern and placement of the tubes 10 and the conductive elements 114 in the bundle 100 may be varied. Further, it would be understood that a connector assembly 110 may be of various configurations as required to interface with the configuration of the tube bundle 100 to which it is assembled. For example, a connector assembly 110 may include one or more of each of an electrical connector 118 to receive, e.g., connect to an electrically conductive element 114 from a mating tube bundle 100, and may further include a fluid connector portion including one or more body portions 82 defining an interior passage 88 which has a connecting interface, such as a flange, collar, barbed extension, etc., whereby a tube 10 in a mating tube bundle 100 may be operatively connected to the connecting interface to join an interior passage 88 of the fluid connector 132 in fluid communication with an interior passage 18 defined by the tube 10. FIG. 24 shows, in a non-limiting example, a tube bundle 100 including a tube 10, which may be a MLT or may be a mono-wall polymer or rubber tube, as described previously, and further including a first and second electrically conductive element 114A, 114B. Each of the respective electrically conductive elements 114A, 114B may be encased, as shown in FIG. 24, by a respective insulating cover 116A, 116B, for example. A bundle cover 62 is in operative connection with the exterior surfaces of the tube 10 and the covers 116A, 116B, to form the tube bundle 100, as previously described. FIG. 25 shows, in another non-limiting example, a tube bundle 100 including a bundle cover 62, a plurality of tubes 10, and a plurality of electrically conductive elements 114, configured as previously described to form a tube bundle 100. It would be understood that these examples are for illustrative purposes and are non-limiting, and other configurations of tube bundles 100 and mating connector assemblies 110 are possible.

FIGS. 26-27 show another non-limiting example of a joint assembly 120 including a tube bundle 100 and a connector assembly 110. FIG. 26 shows a cross-sectional illustration of the tube bundle 100 of FIG. 27, which includes a tube 10, an electrically conductive element 114, which in a non-limiting example is configured as a conductive layer 114 positioned radially outward of the tube 10, and a bundle cover 62 which may also be configured as an insulating layer encasing the conductive layer 114. The tube 10 may be configured as previously described, e.g., as a MLT, or as a mono-wall tube, for example. The conductive element, which may be referred to in the instant example, as a dissipative or conductive layer 114, may be co-extrudable and/or bondable to mating materials, including mating materials comprising the tubing layers of the tube 10 adjacent to conductive layer 114, and including the bundle cover 62. The conductive layer 114 may be applied by a secondary process where, by way of non-limiting example, the conductive layer 114 may include a conductive foil applied to a co-extruded tube, may be configured using a flow coating process, or may consist of winding conductive filaments wound around a tube layer or base tube. The electrically conductive layer 114 may be configured with one or more different conductivity levels, where each of the conductivity levels may be suited for a specific function, for example, to support data transfer, enable power transfer, dissipate currents imparted by adjacent electrical components, dissipate static charge build-up, communicate signals, etc. Electrical conductivity may be imparted to the conductive layer 114 through a polymer additive like metal particles, carbon particles, nano-materials or other specialized additives, where such additives are selected so as to not degrade mechanical, chemical, or life characteristics of the tube bundle 100, or by adding metal or foil layers or fibers to the layer 114, which may require secondary processing of the tube bundle 100. As shown in FIG. 27, the tube bundle 100 is defined by a first end 72, and a second end 78 located distally from the first end 72.

The connector assembly 110 may include a fluid connector portion 132 and an electrical connector portion 138. The fluid connector portion 132 may molded to include a body portion 82, an electrically conductive element 134 and an insert 64. The conductive element 134 may be operatively bonded and/or attached to one or more of the body portion 82 and the insert 64. The conductive element 134 may be configured as described for the conductive element 114, and may be insert molded into the connector 110, or formed and/or included in the connector 110 using a secondary operation. The insert 62, which in a non-limiting example comprises a low WVTR material, defines an interior passage 88 through which a fluid may be conveyed. The connector 132 further includes a collar 84 defining a flange 86. The first end 72 of the tube bundle 100 may be positioned in proximate contact with the collar 84 and the flange 86, and such that the radially outward surface of the insert 64 is in proximate contact with the inner surface of the tube 10 adjacent to the first end 72, to define a joint interface 126. The insert 64 and the tube 10 may be bonded or welded together to form the bonded or welded joint interface 124. As described previously, any suitable form of welding sufficient to weld and/or melt together the materials which are in proximate contact may be used to form the joint interface 124 thus joining the connector assembly 110 to the tube bundle 100. A portion of the bundle cover 62 may be removed from the first end 72 to provide a stripped portion 102 of the tube 10 and a stripped portion 106 of the conductive element 114 to facilitate forming the joint assembly 120. As shown at 138, an electrical connection may be formed between stripped portion 106 of the conductive element 114 and the conductive element 134 of the connector assembly 110, such that the tube bundle 100 would be electrically connected to a device (not shown) electrically connected to the conductive element 134. Optionally, the bundle cover 62 may be bonded and/or welded to the connector 132 to form a joint interface 124.

The examples shown in FIGS. 16-27 are not intended to be limiting and are provided for illustrative purposes, understanding that other configurations, combinations and arrangements of tube bundles including one or more tubes, one or more electrical elements, and/or a combination of these are possible within the scope described herein.

A conductive layer such as layers 114, 134 may provide electrical and/or thermal conductivity of the tube 10 and/or tube bundle 100. Material conductivity of the conductive layer 114 may be imparted through a polymer additive comprising one or more of metal particles, carbon particles, nano-materials or other specialized additives. Other configurations of the conductive layers 114, 134 may include metal or foil layers, or fibers, which may be applied through secondary processing of the tube, tube bundle, and/or connector. An electrically conductive or dissipative layer or element 114 may prevent the build-up of electrical charges and subsequent electrical arcing. Such arcing may cause degradation in tube materials and/or cause holes and leakage of the tube. Such electrical charges can be caused by static electricity charge build-up or due to the proximity to electrically charged devices or current carrying components like wiring. The conductivity of the element or layer 114 must be such that charges can be dissipated in a short enough period of time, and/or that electrical current can be sustained without degrading the polymer material comprising the tube 10 and/or tube bundle 100.

A conductive tube layer or element 114 can be used as a sensing device. Moving devices like pumps, fans, valves, etc. cause electrical or magnetic flux which can be detected and transferred through a conductive element 114 of a tube 10 and/or tube bundle 100. This inductive effect allows a tube 10 and/or tube bundle 100 to function as a sensor to detect pump, fan, or valve operation. Such information can be conducted along the tube 10 and/or tube bundle 100 and transferred to mating components and ultimately to computing devices. The sensing may be simple on/off digital monitoring or electrical signals which may be correlated to device speed, for example, fan or pump rotational speed, or to valve operation characterized by a spike in the electrical signal. A magnet or other ferritic or non-ferritic material may be added to the pump or fan to strengthen electrical or magnetic flux imparted on the conductive element 114 of a tube 10 and/or tube bundle 100. This may allow non-contact monitoring and/or sensing of electrical devices and transmitting electrical signals over a distance as an alternative to a traditional electrical wire. A conductive layer or element 114 may also be used to communicate information through a tube 10 and/or tube bundle 100 and mating components to monitor or control electrical devices in a system including the tube 10 and/or tube bundle 100. A conductive layer or element 114 may convey power between two points or devices in a system, such as between a pump and fan or valves.

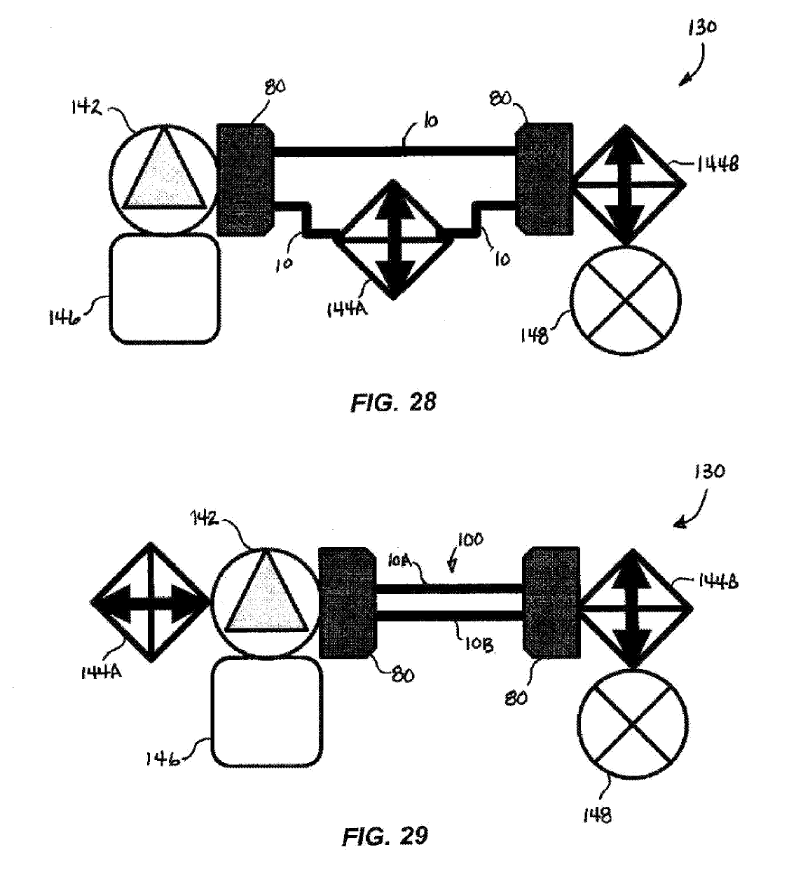

FIGS. 28-31 each show, in a series of non-limiting examples, a schematic illustrative diagram of a fluid system 130 including at least one MLT 10, which may further include at least one tube bundle 100. FIGS. 32-35 each show, in a series of non-limiting examples, a schematic illustrative diagram of a fluid and electrical system 140 including at least one MLT 10 and at least one electrically conductive element 114, which may further include at least one tube bundle 100 which may include at least one electrically conductive element 114. Referring generally to FIGS. 28-35, each system 130, 140 may include one or more fluid handling devices, which may be a combination of one or more of a pump 142, a heat exchanger 144, a fan 148 a reservoir 146, a valve (not shown) and/or other fluid device (not shown). Each of the heat exchangers may be designated as either a heat exchanger 144A extracting heat from a heat source within the system 130, or as a heat exchanger 144B expelling heat from the system 130, for example, via a fan, circulating air, or other cooling source. Each fluid handling device may require one or more fluid connections and/or electrical connections to be actuated and/or to operate in the system 130, 140. By bundling fluid connections and/or electrical connections, the number of joints in the system may be reduced, connection and disconnections simplified, and packaging efficiencies and connection stability and reliability improved by routing tubing or bundled connections between devices.

FIG. 28 shows, in a non-limiting example, a pumped heat exchange system 130 comprising a reservoir 146 in fluid communication with a pump 142. The pump 142 is in fluid communication with a heat exchanger 144A and a heat exchanger 144B via one or more tubes 10, which may be configured as MLT as described herein, and via one or more fluid connectors 80, 132 configured as described herein. A cooling circuit is defined, whereby fluid is pumped through the system 130 including the heat exchangers 144A and 144B, to cool the system 130. Fluid in the fluid circuit defined by the tubes 10, etc. is exchanged and/or replenished with fluid pumped from/to the reservoir 146. It would be understood that additional heat exchangers 144A, 144B may be included in series and/or in parallel with heat and/or cooling sources within the fluid system 130.

FIG. 29 shows, in another non-limiting example, a pumped heat exchange system 130 comprising a reservoir 146 in fluid communication with a pump 142. The pump 142 is in fluid communication with a heat exchanger 144A and a heat exchanger 144B via a tube bundle 100 including a first tube 10A and a second tube 10B, and via one or more fluid connectors 80, where each of the fluid connectors 80 are configured to operatively connect to each of the tubes 10A, 10B in the tube bundle 100, for example, as described for FIG. 17 or 19. The tubes 10A, 10B may be each configured as a MLT or otherwise (e.g., as a mono-wall tube), as described herein. A cooling circuit is defined, whereby fluid is pumped through the system 130 including the heat exchangers 144A and 144B, to cool the system 130. Fluid in the fluid circuit is exchanged and/or replenished with fluid pumped from/to the reservoir 146.

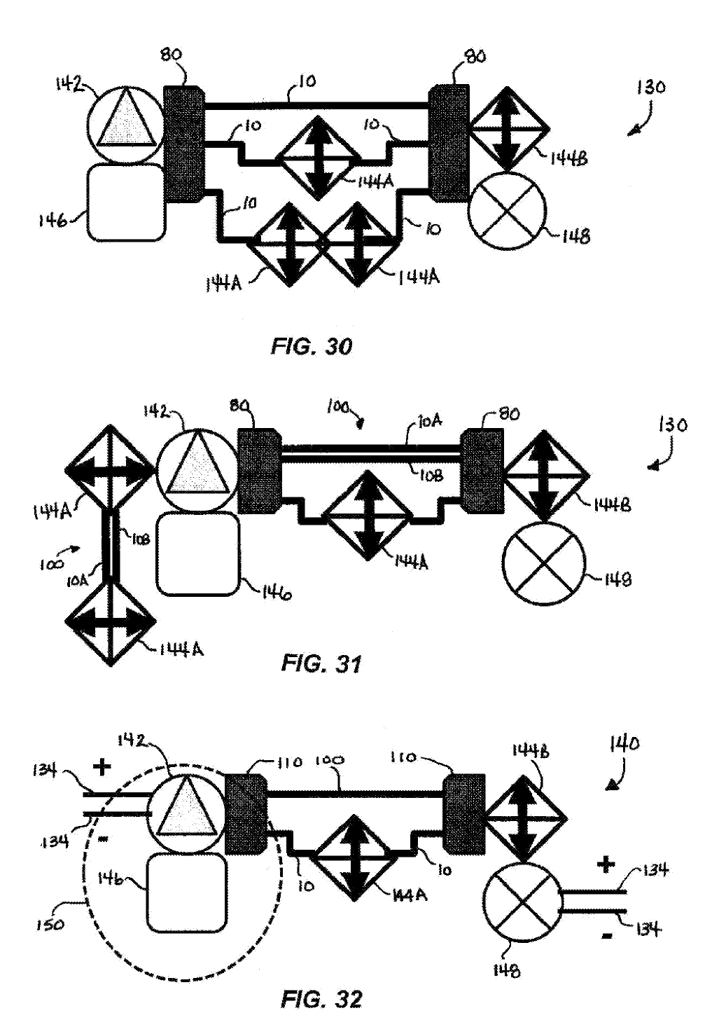

It would be understood that additional heat exchangers 144A, 144B may be included in series and/or in parallel with heat and/or cooling sources within the fluid system 130, as shown in the non-limiting examples of FIGS. 30 and 31. The systems 130 illustrated in FIGS. 30 and 31 comprise elements including a reservoir 146, pump 142, fan 148, a plurality of heat exchangers 144A, 144B and a fluid circuit comprising one or more tubes 10 and/or tube bundles 10, wherein each of these elements may be configured as previously described.

FIGS. 32-35 each show, in a series of non-limiting examples, a schematic illustrative diagram of a fluid and electrical system 140 including at least one MLT 10 and at least one electrically conductive element 114, which may further include at least one tube bundle 100 which may include at least one electrically conductive element 114.

FIG. 32 shows, in a non-limiting example, a pumped heat exchanged system 140 including a heat source 150 comprising a reservoir 146 in fluid communication with a pump 142. The pump 142 is in fluid communication with a heat exchanger 144A and a heat exchanger 144B via one or more tubes 10 and a tube bundle 100, and via one or more fluid connectors 132 and/or connector assemblies 110, configured as described herein. The pump 142 is electrically connected to at least the fan 148 via a conductive element 114 (not shown) included in the tube bundle 100, and through electrical connectors 138 (not shown) electrically connected to the electrical elements 134 of the pump 142 and the fan 148. The conductive element 114 and the electrical connectors 138 may be configured, for example, as described for FIGS. 20-27. A cooling circuit is defined, whereby fluid is pumped through the system 140 including the heat exchangers 144A and 144B, to cool the system 140. Fluid in the fluid circuit defined by the tubes 10, etc. is exchanged and/or replenished with fluid pumped from/to the reservoir 146. It would be understood that additional heat exchangers 144A, 144B may be included in series and/or in parallel with heat and/or cooling sources within the fluid system 140.

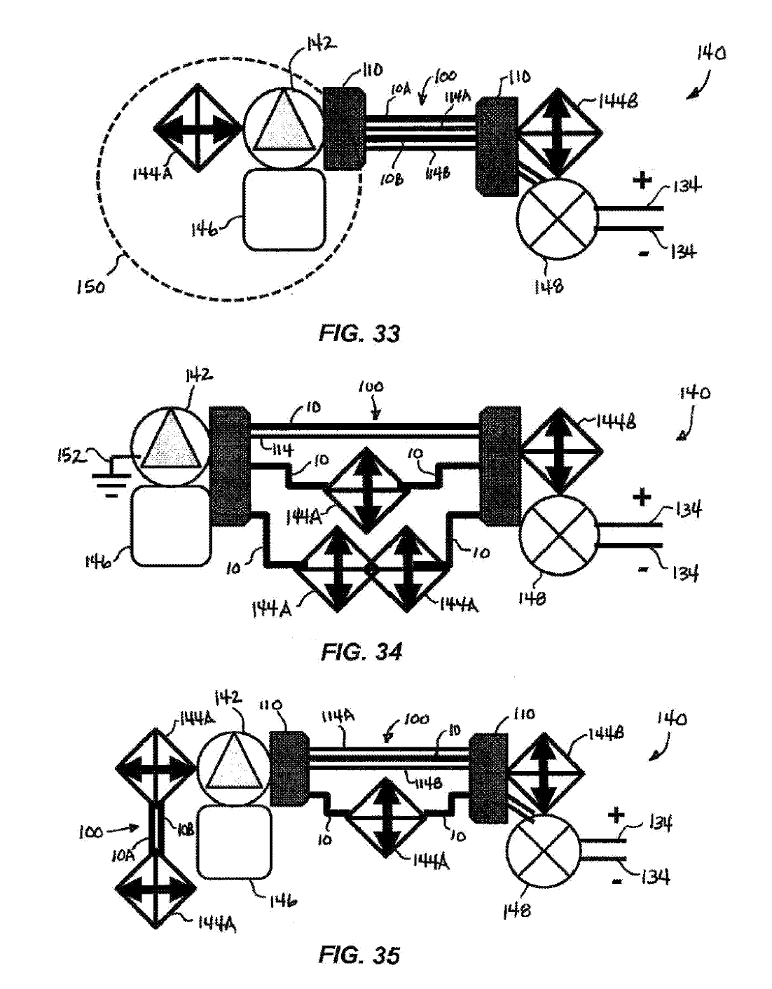

It would be understood that other configurations of a fluid and electrical system 140 are possible. In additional non-limiting examples in each of FIGS. 33-35, a pumped heat exchanged system 140 is shown including a heat source 150 comprising a reservoir 146 in fluid communication with a pump 142. The pump 142, which may be grounded at 152, is in fluid communication with at least one heat exchanger 144A and at least one heat exchanger 144B via a plurality of tubes 10 and/or tube bundles 100, and via one or more fluid connectors 80 and/or connector assemblies 110, configured as described herein. The pump 142 is electrically connected to at least the fan 148 via at least one conductive element 114 (114A, 114B) included in a tube bundle 100, and through electrical connectors 138 (not shown) electrically connected to the electrical elements 134 of the pump 142 and the fan 148. The conductive element 114 and the electrical connectors 138 may be configured, for example, as described for FIGS. 20-27. A cooling circuit is defined, whereby fluid is pumped through the system 140 including the heat exchangers 144A and 144B, to cool the system 140. Fluid in the fluid circuit defined by the tubes 10, etc. is exchanged and/or replenished with fluid pumped from/to the reservoir 146. It would be understood that additional heat exchangers 144A, 144B may be included in series and/or in parallel with heat and/or cooling sources within the fluid system 140.

The examples provided herein are intended to be non-limiting. It would be understood that the various multi-layer tubing, tube and joint connections, fluid systems and fluid/electric systems as described herein and variations thereof may be configured for use in a broad scope of systems and applications, including but not limited to electronics cooling, including cooling of microprocessors, video graphics cards, hard drives, central processing units, televisions, LED lighting, video projectors, power electronics including but not limited to rectifiers and insulated gate bipolar transistors (IGBT), transformers, solar cell and solar collector applications. Other non-limiting applications for the apparatus and methods as described herein include medical applications requiring the transport, conveyance or monitoring of medical and bodily fluids, urinalysis, blood analysis, infusion, transfusion, and/or dialysis, medical testing devices, etc. Further non-limiting applications including plumbing, faucet systems, water supply systems, food service applications, food packaging and handling, packaging equipment, vending machine applications including beverage vending. Other applications include automotive or other vehicle applications such as liquid or fluid cooling (engines, transmissions, etc.), vehicle electronics cooling, thermal distribution, storage and redistribution in vehicles, electric vehicle (EV), hybrid electric vehicle (HEV) and fuel cell applications, diesel urea injection systems, oil and/or fuel transmission, etc. Various other industrial applications are possible, including but not limited to configurations which may be usable for ink jet printing, aerospace fluid applications, chemical processing (semi-conductor, etc.), steam distribution systems, fluid measuring, test, and observation equipment, and/or remote systems including standby power systems or other remote fluid systems.

While the best modes for carrying out the invention have been described in detail, those familiar with the art to which this invention relates will recognize various alternative designs and embodiments for practicing the invention within the scope of the appended claims.

1. A multi-layer tube comprising:
an inner layer including a melt-extrudable polymeric material, the melt-extrudable polymeric material including a fluoropolymer; and
at least one additional layer positioned radially outward of the inner layer, wherein said at least one additional layer includes a flame resistant melt-extrudable polymeric material and is configured to minimize oxygen permeation through said at least one additional layer; and
wherein the inner layer and the at least one additional layer are bonded to one another.

2. The multi-layer tube of claim 1, wherein the inner layer is configured to inhibit transmission of water vapor through the multi-layer tube.

3. The multi-layer tube of claim 1, wherein said at least one additional layer is flame resistant greater than UL-94 HB.

4. The multi-layer tube of claim 1, wherein said at least one additional layer comprises a functionalized polymer which is bondable to the inner layer.

5. The multi-layer tube of claim 1, wherein the inner layer and said at least one additional layer are co-extruded to form the multi-layer tube.

6. The multi-layer tube of claim 1, wherein at least two of the inner layer and said at least one additional layer are configured to define a non-uniform bond layer therebetween.

7. The multi-layer tube of claim 1, at least one of the inner layer and said at least one additional layer is characterized by an irregular surface profile defining a non-uniform bond layer with an adjacent layer.

8. The multi-layer tube of claim 1, wherein said at least one additional layer includes at least a second layer and a cover layer; wherein:
the inner layer is configured to inhibit transmission of water vapor through the inner layer,
the second layer comprises a functionalized polymer which is bondable to the inner layer; and
the cover layer is flame resistant greater than UL-94 HB; and
wherein the cover layer is configured to be radially outward of the second layer.

9. The multi-layer tube of claim 1, wherein the at least one additional layer includes at least one intermediate layer and a cover layer, and wherein:
the inner layer is configured to inhibit transmission of water vapor through the inner layer;
the inner layer and said at least one intermediate layer are bonded to each other; the cover layer is flame resistant greater than UL-94 HB; and
the cover layer is radially outward of said at least one intermediate layer.

10. The multi-layer tube of claim 9, wherein said at least one intermediate layer comprises a functionalized polymer which is bondable to the inner layer.

11. The multi-layer tube of claim 9, wherein said at least one intermediate layer is configured as a flexible layer.

12. The multi-layer tube of claim 9, wherein said at least one intermediate layer is configured as a barrier layer.

13. The multi-layer tube of claim 9, wherein said at least one intermediate layer is configured as a thermal insulating layer.

14. The multi-layer tube of claim 9, wherein said at least one intermediate layer is configured as a non-plasticized layer.

15. The multi-layer tube of claim 14, wherein the non-plasticized layer is configured as one of an inert layer and a non-reactive layer.

16. The multi-layer tube of claim 14, wherein the multi-layer tube is configured as one of a medical grade tube and a food grade tube.

17. The multi-layer tube of claim 9, wherein said at least one intermediate layer is configured as one of a translucent layer and a transparent layer.

18. The multi-layer tube of claim 9, wherein said at least one intermediate layer is configured as a reinforcement layer.

19. The multi-layer tube of claim 9, wherein said at least one intermediate layer is configured as a thermally conductive layer.

20. The multi-layer tube of claim 9, wherein said at least one intermediate layer is configured as one of an electrically dissipative layer and an electrically conductive layer.

21. The multi-layer tube of claim 1, further comprising:
a bundle cover configured to encase the multi-layer tube and at least one bundled element; and
wherein the bundle cover is operatively attached to the multi-layer tube and to said at least one bundled element to define a tube bundle.

22. The multi-layer tube of claim 21, wherein the bundle cover is operatively attached to the multi-layer tube and to said at least one bundled element by at least one of a mechanical bond, a chemical bond, and an adhesive.

23. The multi-layer tube of claim 21, wherein the bundle cover is operatively attached to the multi-layer tube and to said at least one bundled element by co-extrusion.

24. The multi-layer tube of claim 21, wherein the multi-layer tube is a first multi-layer tube, and wherein said at least one bundled element is configured as at least one other multi-layer tube.

25. The multi-layer tube of claim 21, wherein said at least one bundled element is configured as an electrically conductive element.

26. The multi-layer tube of claim 21, wherein the multi-layer tube is a first multi-layer tube, and wherein said at least one bundled element is configured as one of at least one other multi-layer tube and at least one electrically conductive element.

27. The multi-layer tube of claim 21, wherein the multi-layer tube is a first multi-layer tube, and wherein said at least one bundled element includes at least one other multi-layer tube and at least one electrically conductive element.

28. A method for connecting a multi-layer tube to a fluid supply system, the method comprising:
positioning an end of a multi-layer tube in proximate contact with an interfacing portion of a connector;
joining the multi-layer tube to the interfacing portion of the connector to form a seal between the multi-layer tube and the connector;
wherein the multi-layer tube includes an inner layer has a melt-extrudable polymeric material including a fluoropolymer and configured in a bonded relationship to
at least one additional layer positioned radially outward of the inner layer, wherein said at least one additional layer has a flame resistant melt-extrudable polymeric material and is configured to minimize oxygen permeation through said at least one additional layer; and
wherein the seal is one of a hermetic seal and a low water vapor transmission seal.

29. The method of claim 28, wherein the multi-layer tube is joined to the interfacing portion of the connector by one of bonding and welding.

30. The method of claim 28, wherein the interfacing portion is defined by a collar of the connector, the method further comprising:
positioning the end of the multi-layer tube in abutting contact with the collar; and
joining the end of the multi-layer tube to the collar by welding.

31. The method of claim 28, wherein the interfacing portion is defined by a flange of the connector, the method further comprising:
inserting the end of the multi-layer tube into the flange such that an outer surface of the multi-layer tube is in proximate contact with the flange; and
joining the multi-layer tube to the flange by welding to form the seal.

32. The method of claim 31, wherein the flange defines a flash trap configured to contain material displaced by welding.

33. The method of claim 28, wherein the interfacing portion is defined by a collar and a flange of the connector, the method further comprising:
inserting the end of the multi-layer tube into the flange such that an outer surface of the multi-layer tube is in proximate contact with the flange; and
positioning the end of the multi-layer tube in abutting contact with the collar; and
joining the multi-layer tube to at least one of the flange and the collar to form the seal.

34. The method of claim 28, wherein the interfacing portion is at least partially defined by an insert of the connector, the method further comprising:
positioning an end of a multi-layer tube in proximate contact with the interfacing portion defined by the insert; and
joining the multi-layer tube to the interfacing portion of the insert to form a seal between the multi-layer tube and the connector.

35. The method of claim 34, wherein the insert is substantially constructed of a bondable polymer.

36. The method of claim 34, wherein the insert is formed in the connector using a multiple-shot molding process.

37. The method of claim 28, wherein the interfacing portion is defined by a barbed portion of the connector, the method further comprising:
inserting a portion of the multi-layer tube over the barbed portion such that the inner layer surface of the portion of the multi-layer tube is in proximate contact with the barbed portion, and such that the portion of the multi-layer tube is retained by the barbed portion to define at least one sealing interface forming the seal.

38. The method of claim 37, further comprising:
operatively attaching a retaining element to the portion of the multi-layer tube inserted over the barbed portion, wherein the retaining element is configured to apply pressure to the portion of the multi-layer tube inserted over the barbed portion and to the at least one sealing interface.

39. The method of claim 38, wherein the portion of the multi-layer tube inserted over the barbed portion includes a modified portion defined by the absence of said at least one additional layer, and an unmodified portion.

40. The method of claim 39, wherein the retaining element is configured to apply pressure to the modified portion and to the unmodified portion.

41. The method of claim 37, wherein the interfacing portion is further defined by a collar and a flange of the connector, the method further comprising:
inserting the end of the multi-layer tube into the flange such that an outer surface of the multi-layer tube is in proximate contact with the flange;
positioning the end of the multi-layer tube in abutting contact with the collar; and
joining the multi-layer tube to at least one of the flange and the collar to form the seal.

42. The method of claim 28, wherein the connector is configured with a first interfacing portion and a second interfacing portion, the method further comprising:
positioning the end of the multi-layer tube in proximate contact with the first interfacing portion of the connector;
joining the multi-layer tube to the first interfacing portion of the connector to form a seal between the multi-layer tube and the connector;
positioning a second element in proximate contact with the second interfacing portion of the connector; and
joining the second element to the second interfacing portion of the connector.

43. The method of claim 42, wherein the second element is another multi-layer tube; and
wherein joining said another multi-layer tube to the second interfacing portion of the connector forms one of a hermetic seal and a low water vapor transmission seal therebetween.

44. The method of claim 42, wherein the second element is an electrically conductive element; and
wherein joining the electrically conductive element to the second interfacing portion of the connector forms an electrical connection therebetween.

45. The method of claim 42, wherein the multi-layer tube and the second element are encased in a bundle cover to form a tube bundle.
